(19) United States
(12) Patent Application Publication
(10) Pub. No.: US 2021/0170446 A1
(43) Pub. Date: Jun. 10, 2021

(54) METHOD FOR FORMING MULTILAYER COATING FILM

(71) Applicant: KANSAI PAINT CO., LTD., Amagasaki-shi, Hyogo (JP)

(72) Inventors: Hirokazu OKAZAKI, Hiratsuka-shi, Kanagawa (JP); Nobuhiko NARITA, Hiratsuka-shi, Kanagawa (JP)

(21) Appl. No.: 17/270,320

(22) PCT Filed: May 20, 2019
(86) PCT No.: PCT/JP2019/019881

§ 371 Date: Feb. 22, 2021

(30) Foreign Application Priority Data
Aug. 31, 2018 (JP) 2018-163964

(51) Int. Cl. B05D 7/00; B05D 5/06; C09D 133/08; C09D 101/02; C09D 7/61; C09D 7/43

(52) U.S. Cl. CPC B05D 7/576; B05D 5/065; C09D 133/08; C08K 3/08; C09D 7/61; C09D 7/43; C09D 101/02

(57) ABSTRACT

A method for forming a multilayer coating film includes forming a base coating film, a photoluminescent coating film, and forming a clear coating in this order, wherein the photoluminescent coating film uses a photoluminescent pigment dispersion containing a scaly photoluminescent pigment having a thickness T of 1 to 65 nm, wherein when all photoluminescent pigment present in the multilayer coating film is projected onto the surface of the multilayer coating film, the area occupancy ratio R indicating how much of the surface of the multilayer coating film is occupied by the parts in which the photoluminescent pigment is projected, is 0.1 to 50 percent; and the T and R satisfy “T (nm)×R (%)≤2000”. The obtained multilayer coating film can manifest excellent photoluminescence.

### TECHNICAL FIELD

The present invention relates to a method for forming multilayer coating film by which a metallic coating film having a less grainy feel and excellent metallic gloss can be formed, as well as a coated product and a multilayer coating film.

### BACKGROUND ART

The purpose of applying a coating material is primarily to protect, and add an aesthetic feel to, a base material. It is important for industrial products to have an aesthetic feel, especially “texture,” in the sense that it enhances their product appeal.

In recent years, designs featuring coated surfaces which appear very bright in highlight conditions but whose brightness drops suddenly when they are tilted, if only by a little, are considered attractive (aesthetic) because of the change in brightness, and such designs are therefore in demand.

In general, coating films employed by these designs are formed by multilayer coating films comprising metallic coating films, using photoluminescent coating material compositions containing photoluminescent pigments.

Drawing attention as the aforementioned metallic coating films, are metallic gloss coating films, etc., whose texture is characterized in that the surface has no grainy feel just like a mirror surface, and that the coated sheet appears glossy under light near specular reflection light (highlight) but dark from angled directions (shade), i.e., there is a large luminance difference between the highlight region and the shade region.

Patent Literature 1 discloses a multilayer coating film comprising: a colored base layer containing a coloring material, which is formed directly or indirectly on the surface of a coating target; and a photoluminescent material-containing layer containing a flaky photoluminescent material and a coloring material, which is overlaid on top of the colored base material; wherein the multilayer coating film is characterized in that: the surface smoothness of the colored base layer is 8 or less based on the value of Wd measured with BYK-Gardner's Wave Scan DOI (product name); the thickness of the flaky photoluminescent material is 25 nm to 200 nm, or preferably 80 to 150 nm; the thickness of the photoluminescent material-containing layer is 1.5 μm or more but no more than 6 μm; and, when all photoluminescent material present in the photoluminescent material-containing layer is projected onto the surface of the photoluminescent material-containing layer, the area occupancy ratio of the parts in which the photoluminescent material is projected, on the surface, is 30 percent or higher but no higher than 90 percent.

However, the multilayer coating film disclosed specifically in Patent Literature 1 is inadequate in that it uses aluminum flakes of 110 nm in thickness as the photoluminescent material, which makes the grainy feel too noticeable and the luminance difference between the highlight region and the shade region small.

Patent Literature 2 discloses a multilayer coating film comprising: a base-layer coating film formed directly or indirectly on the surface of a coating target; and a top-layer coating film layered on top of the base-layer coating film; wherein the multilayer coating film is characterized in that: the brightness value L* of the base-layer coating film is 30 or lower; the top-layer coating film contains a large quantity of aluminum flakes as a photoluminescent material; the surface roughness Ra of the aluminum flakes is 30 nm or lower; the thickness of the aluminum flakes is 70 nm or more but no more than 150 nm; the aluminum flakes contained in the top-layer coating film have an aspect ratio—calculated by dividing their long diameter by their short diameter—of 3 or lower, an average grain size of 7 μm or greater but no greater than 15 μm when the grain size represents the square root of the product of their long diameter and their short diameter, and a standard deviation of grain size distribution corresponding to 30 percent of the average grain size or lower; and, when all aluminum flakes present in the top-layer coating film are projected onto the surface of the top-layer coating film, the projected area occupancy ratio of the parts in which the aluminum flakes are projected, on the surface, is 40 percent or higher but no higher than 90 percent. However, the multilayer coating film described in Patent Literature 2 uses a scaly photoluminescent pigment with a thickness of 70 nm or more and thus pertains to a technical idea different from that of the present invention where the scaly photoluminescent pigment has a thickness T of 1 to 65 nm.

Patent Literature 3 discloses a method for forming multilayer coating film by heating an uncured colored coating film, an uncured photoluminescent coating film, and an uncured clear coating film, which have been formed by applying on a coating target a colored coating material (X), a photoluminescent pigment dispersion (Y), and a clear coating material (Z), in this order, and then simultaneously curing these three coating films; wherein the method for forming multilayer coating film is such that: the photoluminescent pigment dispersion (Y) contains water, a specific surface conditioner, a scaly photoluminescent pigment, and a viscosity-adjusting agent; and the 550-nm wavelength light transmittance of a film, obtained by applying the photoluminescent pigment dispersion (Y) to a cured film thickness of 0.2 μm, is 10 to 50 percent.

However, although the method for forming multilayer coating film described in Patent Literature 3 uses 50-nm vapor-deposited aluminum flakes as the photoluminescent pigment flakes, there is no mention of the area occupancy ratio indicating how much of the surface of the multilayer coating film is occupied by the parts in which the photoluminescent pigment is projected when all photoluminescent pigment present in the multilayer coating film is projected onto the surface of the multilayer coating film. Also, there is no mention of keeping to a specific range provided under the present invention, of the relationship between the thickness of the vapor-deposited aluminum flakes and the area occupancy ratio, on the surface of the multilayer coating film, of the parts in which the photoluminescent pigment is projected.

### BACKGROUND ART LITERATURE

### Patent Literature

### Patent Literature 1: Japanese Patent Laid-open No. 2017-019147

### Patent Literature 2: International Patent Laid-open No. 2017/146150

### Patent Literature 3: International Patent Laid-open No. 2017/022698

### SUMMARY OF THE INVENTION

### Problems to be Solved by the Invention

An first object of the present invention is to provide a method for forming multilayer coating film by which a multilayer coating film having a less grainy feel and excellent metallic gloss can be formed.

A second object of the present invention is to provide a coated product having a less grainy feel and excellent metallic gloss, obtained by the aforementioned method for forming multilayer coating film.

A third object of the present invention is to provide a multilayer coating film having a less grainy feel and excellent metallic gloss.

### Means for Solving the Problems

According to the first embodiment of the present invention, a method for forming multilayer coating film pertaining to Item 1 to Item 6 below is provided:

Item 1: A method for forming multilayer coating film that includes Steps (1) to (3) below in this order:

(1) a step to form a base coating film on a coating target by applying a base coating material (X);

(2) a step to form a photoluminescent coating film by applying a photoluminescent pigment dispersion (Y); and

(3) a step to form a clear coating film by applying a clear coating material (Z);

wherein the method for forming multilayer coating film is such that:

the photoluminescent pigment dispersion (Y) is a photoluminescent pigment dispersion containing a scaly photoluminescent pigment (A) and the thickness T of the scaly photoluminescent pigment (A) is 1 to 65 nm;

when all photoluminescent pigment present in the multilayer coating film is projected onto the surface of the multilayer coating film, the area occupancy ratio R indicating how much of the surface of the multilayer coating film is occupied by the parts in which the photoluminescent pigment is projected, is 0.1 to 50 percent; and

the T and R satisfy Requirement (1) below:

T (nm)×R (%)≤2000 (1)

Item 2: The method for forming multilayer coating film according to Item 1, wherein the Y value (Y5) indicating the luminance, in the XYZ colorimetric system based on spectral reflectivity, of the multilayer coating film when a light irradiated thereon at a 45-degree angle is received at a 5-degree angle in the direction of the incident light relative to the specular reflection light, is 20 to 1500.

Item 3: The method for forming multilayer coating film according to Item 1 or 2, wherein the HG value of the multilayer coating film is in a range of 5 to 66.

Item 4: The method for forming multilayer coating film according to any one of Items 1 to 3, wherein the content of the scaly photoluminescent pigment (A) is 0.2 to 80 parts by mass relative to 100 parts by mass of the total solids content in the photoluminescent pigment dispersion (Y).

Item 5: The method for forming multilayer coating film according to any one of Items 1 to 4, wherein the photoluminescent pigment dispersion (Y) contains a viscosity-adjusting agent.

Item 6: The method for forming multilayer coating film according to any one of Items 1 to 5, wherein the clear coating material (Z) is a two-component type clear coating material containing a hydroxyl group-containing resin and a polyisocyanate compound.

Also, according to the second embodiment of the present invention, a coated product having, on its surface, a multilayer coating film obtained by the method for forming multilayer coating film in the aforementioned first embodiment, is provided.

Also, according to the third embodiment of the present invention, a multilayer coating film is provided that comprises a base coating film that has been formed on the surface of a coating target, a photoluminescent coating film containing a scaly photoluminescent pigment (A), and a clear coating film, in this order, wherein the multilayer coating film is such that:

the thickness T of the scaly photoluminescent pigment (A) is 1 to 65 nm;

when all photoluminescent pigment present in the multilayer coating film is projected onto the surface of the multilayer coating film, the area occupancy ratio R indicating how much of the surface of the multilayer coating film is occupied by the parts in which the photoluminescent pigment is projected, is 0.1 to 50 percent; and the T and R satisfy Requirement (1) below:

T (nm)×R (%)≤2000 (1)

### Effects of the Invention

According to the method for forming multilayer coating film proposed by the present invention, a multilayer coating film having a less grainy feel and excellent metallic gloss can be obtained.

The coated product proposed by the present invention has, on its surface, a multilayer coating film having a less grainy feel and excellent metallic gloss.

The multilayer coating film proposed by the present invention is a multilayer coating film having a less grainy feel and excellent metallic gloss.

### BRIEF DESCRIPTION OF THE DRAWINGS

FIG. 1 A graph showing the relationships, in the Examples and Comparative Examples, of the thickness T (nm) of the scaly photoluminescent pigment (A) contained in the photoluminescent pigment dispersion (Y) that forms the photoluminescent coating film, and the area occupancy ratio R (%) indicating how much of the surface of the multilayer coating film is occupied by the parts in which the photoluminescent pigment is projected when all photoluminescent pigment present in the multilayer coating film is projected onto the surface of the multilayer coating film.

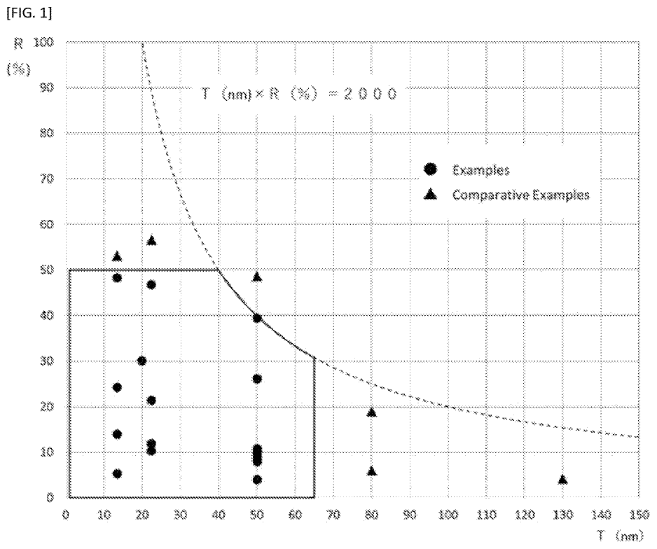

### MODE FOR CARRYING OUT THE INVENTION

### First Embodiment

The first embodiment of the present invention is explained.

### [1-1. Step (1)]

Step (1) is a step to form a base coating film on a coating target by applying a base coating material (X) thereon.

### <Coating Target>

Under the method for forming multilayer coating film proposed by the present invention, the material for the coating target may be any of iron, zinc, aluminum, titanium, and other metals, alloys containing the foregoing metals, glass, ceramics, inorganic materials, various plastics, wood, and the like. Also, it may be a composite body consisting of a plastic and various fibers (carbon fibers, glass fibers, metal fibers, organic fibers, etc.). The coating target may be shaped as a sheet (film), cylinder, line, band, foam, any combination thereof, or molding obtained by molding at least one type of material selected from the foregoing. Any such material may be degreased or surface-treated, as deemed appropriate, for use as a coating target. The surface treatment may be, for example, phosphate treatment, chromate treatment, composite oxide treatment, etc. Furthermore, when the material for the aforementioned coating target is a metal, preferably a cationic electrodeposition coating film has been formed, by a cationic electrodeposition coating material, on the surface-treated metal material. A middle-coat coating film may have been formed on the cationic electrodeposition coating film. Preferably the middle-coat coating film is colored from the viewpoints of substrate-concealing property, weather resistance, etc. Particularly when the base coating material (X) described below is transparent, preferably a colored middle-coat coating film has been formed from the viewpoints of substrate-concealing property, weather resistance, etc.

Also, when the material for the coating target is a plastic, preferably a primer coating film has been formed, by a primer coating material, on the degreased plastic material

### <Base Coating Material (X)>

Specifically, for the base coating material (X), any of thermosetting coating materials which by themselves are known, and whose primary components are solvent and thermosetting resin, may be used. The thermosetting coating materials may be interpreted to include so-called middle-coat coating materials. The base coating material (X) may be transparent, or it may be colored.

The solvent used in the base coating material (X) may be an organic solvent and/or water.

Specifically, for the organic solvent used in the base coating material (X), any of organic solvents normally used in coating materials may be used.

For example, these organic solvents include, for example, toluene, xylene, hexane, heptane, and other hydrocarbons; ethyl acetate, butyl acetate, ethylene glycol monomethyl ether acetate, diethylene glycol monoethyl ether acetate, diethylene glycol monobutyl acetate, and other esters; ethylene glycol monomethyl ether, ethylene glycol diethyl ether, diethylene glycol monomethyl ether, diethylene glycol dibutyl ether, and other ethers; butanol, propanol, octanol, cyclohexanol, diethylene glycol, and other alcohols; and methyl ethyl ketone, methyl isobutyl ketone, cyclohexane, isophorone, and other ketones. Any of the foregoing may be used alone, or two or more types may be used in combination.

For the thermosetting resin used in the base coating material (X), preferably a base resin is combined with a crosslinking agent from the viewpoints of water resistance, chemical resistance, weather resistance, etc.

Suitable choices for the base resin include resins having good weather resistance, transparency, etc., or specifically acrylic resins, polyester resins, epoxy resins, urethane resins, and the like.

The aforementioned acrylic resins include, for example, resins obtained by copolymerizing (meth)acrylic acid esters containing carboxyl groups, hydroxyl groups, amide groups, methylol groups, and other functional groups, other (meth)acrylic acid esters, styrene, etc.

For the polyester resins, those obtained by condensation-reacting polybasic acids, polyalcohols, and denatured oils using common methods, may be used.

The epoxy resins include, for example, epoxy ester resins, etc., obtained by the method of synthesizing an epoxy ester by reacting epoxy groups with an unsaturated fatty acid and then adding an α,β-unsaturated acid to the resulting unsaturated groups, the method of esterifying the hydroxyl groups of an epoxy ester with phthalic acid, trimellitic acid, or other polybasic acid, and the like.

The urethane resins include, for example, compounds obtained through addition reaction of a diisocyanate compound or other polyisocyanate compound and a diol or other polyalcohol, as well as higher-molecular-weight versions of the aforementioned acrylic resins, polyester resins, and epoxy resins, obtained by reacting them with a diisocyanate compound or other polyisocyanate compound.

The base coating material (X) may be either an aqueous coating material or solvent-based coating material, but desirably it is an aqueous coating material from the viewpoint of making it a low-VOC coating material. When the base coating material (X) is an aqueous coating material, a resin containing hydrophilic groups, such as carboxyl groups, hydroxyl groups, methylol groups, amino groups, sulfonic acid groups, polyoxyethylene bonds, etc., or most commonly carboxyl groups, by sufficient quantity to water-solubilize or water-disperse the resin, may be used as the base resin, and the base resin may be water-solubilized or water-dispersed by neutralizing the hydrophilic groups into alkali salts. In this case, the quantity of hydrophilic groups, such as carboxyl groups, is not limited in any way and any quantity may be selected according to the degree of water-solubilization or water-dispersion; in general, however, it is approx. 10 mgKOH/g or greater, or preferably in a range of 30 to 200 mgKOH/g, based on the acid value. Also, alkaline substances that may be used for neutralization include, for example, sodium hydroxide, amine compounds, and the like.

Also, the aforementioned resin may be water-dispersed by emulsion-polymerizing the aforementioned monomer components in the presence of a surface-active agent or water-soluble resin. Furthermore, it may be achieved by dispersing the aforementioned resin in water in the presence of, for example, an emulsifier, etc. When undergoing this water-dispersion, the base resin may not contain any of the aforementioned hydrophilic groups, or it may contain less of them than the aforementioned water-soluble resin.

The aforementioned crosslinking agent is a component for crosslinking and thus curing the aforementioned base resin through heating, where examples include amino resins, polyisocyanate compounds, blocked polyisocyanate compounds, epoxy group-containing compounds, carboxyl group-containing compounds, carbodiimide group-containing compounds, hydrazide group-containing compounds, semicarbazide group-containing compounds, etc. Among these, amino resins, polyisocyanate compounds, and blocked polyisocyanate compounds reactive to hydroxyl groups, as well as carbodiimide group-containing compounds reactive to carboxyl groups, are preferred. As for polyisocyanate compounds and blocked polyisocyanate compounds, those mentioned in the <Clear Coating Material (Z)> section below may be used. Any of the aforementioned crosslinking agents may be used alone, or two or more types may be used in combination.

To be specific, amino resins obtained by condensing or co-condensing melamine, benzoguanamine, urea, etc., with formaldehyde, or by further etherifying them using lower monohydric alcohols, may be suitably used. In addition, polyisocyanate compounds or blocked polyisocyanate compounds may also be suitably used.

The ratio of each of the aforementioned components in the base coating material (X) can be selected in any way as desired according to the need; from the viewpoints of water resistance, finish quality, etc., however, preferably the base resin and crosslinking agent are adjusted, based on the total mass of both components, to a range of 60 to 90 percent by mass, or particularly 70 to 85 percent by mass, for the former, and to a range of 10 to 40 percent by mass, or particularly 15 to 30 percent by mass, for the latter, in general.

Furthermore, pigments, pigment dispersants, anti-settling agents, defoaming agents, UV absorbents, etc., may also be compounded into the base coating material (X) as deemed appropriate.

The aforementioned pigments include, for example, colored pigments, extender pigments, photoluminescent pigments, rustproof pigments, etc., among which use of colored pigments is preferred, while use of pigments of desired colors is more preferred based on the viewpoint, for example, of obtaining a coating film offering excellent substrate-concealing property and design property.

Any of the aforementioned pigments may be used in combination as deemed appropriate according to the light transmittance, substrate-concealing property, desired hue, etc.

The pigment use quantity, from the viewpoints of substrate-concealing property, weather resistance, etc., may be such that the light transmittance of the cured coating film to be formed by the base coating material (X) becomes 10 percent or lower, or preferably 5 percent or lower, at wavelengths in a range of 400 to 700 nm. It should be added that, if the base coating material (X) is transparent, the pigment quantity may be in a range where the transparency of the base coating material (X) is not reduced.

If the base coating material (X) is colored, from the viewpoint of substrate-concealing property, desirably the brightness value L* of the coating film to be obtained is adjusted to a range of 0.1 to 95, or preferably 0.1 to 70, or more preferably 0.1 to 60, by adjusting the types and compounding quantities of the aforementioned pigments.

As for the aforementioned colored pigments, any one type, or combination of more types, selected from among the following may be used: complex metal oxide pigments, black iron oxide pigments, black titanium oxide pigments, perylene black pigments, carbon black pigments, titanium white, zinc molybdate, calcium molybdate, Prussian blue, ultramarine blue, cobalt blue, copper phthalocyanine blue, indanthrone blue, chrome yellow, synthetic yellow iron oxide, bismuth vanadate, titanium yellow, zinc yellow, monoazo yellow, ocher, monoazo yellow, disazo, isoindolinone yellow, metal complex salt azo yellow, quinophthalone yellow, benzimidazolone yellow, red iron oxide, monoazo red, monoazo red, unsubstituted quinacridone red, azo lake (Mn salt), quinacridone magenta, anthanthrone orange, dianthraquinonyl red, perylene maroon, quinacridone magenta, perylene red, diketopyrrolopyrrole chrome vermilion, chlorinated phthalocyanine green, brominated phthalocyanine green, and others such as pyrazolone orange, benzimidazolone orange, dioxazine violet, perylene violet, etc.

Additionally, transparent colored pigments may also be used as colored pigments.

As for the aforementioned transparent colored pigments, any one type, or combination of more types, selected from among the following may be used: titanium yellow and other complex metal oxide pigments, azo-based pigments, quinacridone-based pigments, diketopyrrolopyrrole-based pigments, perylene-based pigments, perinone-based pigments, benzimidazolone-based pigments, isoindoline-based pigments, isoindolinone-based pigments, metal chelate azo-based pigments, phthalocyanine-based pigments, indanthrone-based pigments, dioxane-based pigments, indigo-based pigments, etc.

As for the aforementioned extender pigments, any one type, or combination of more types, selected from among the following may be used, for example: barium sulfate, barium carbonate, calcium carbonate, aluminum silicate, silica, magnesium carbonate, talc, alumina white, etc.

As for the aforementioned photoluminescent pigments, granular or flaky (scaly or sliver-like) metals, flaky (scaly or sliver-like) glass and metal oxides, pulverized products of vapor-deposited films, and oxide-coated products thereof, etc., may be used, for example.

As for the aforementioned granular or flaky (scaly or sliver-like) metals, any one type, or combination of more types, selected from among the following may be used, for example: grains and flakes of aluminum, copper, zinc, nickel, chrome, stainless steel, brass, nickel alloy, and other metals, etc.

As for the flaky (scaly or sliver-like) glass and metal oxides, any one type, or combination of more types, selected from among the following may be used, for example: glass flakes, natural mica, artificial mica, alumina flakes, silica flakes, etc.

As for the aforementioned pulverized products of vapor-deposited films, any one type, or combination of types, selected from among the following may be used: those known as vapor-deposited metal flake pigments, each obtained by vapor-depositing aluminum, gold, silver, copper, brass, titanium, chrome, nickel, nickel chrome, stainless steel, or other metal onto a film or other base material, separating the base material, and then pulverizing the vapor-deposited metal film.

As for the aforementioned oxide-coated products thereof, any one type, or combination of types, selected from among the following may be used: the aforementioned granular or flaky (scaly or sliver-like) metals, flaky (scaly or sliver-like) glass, and metal oxides, or pulverized products of vapor-deposited films, etc., that have been coated with oxides of alumina (aluminum oxide), silica (silicon oxide), mica, titanium oxide, and/or iron oxide.

As for the aforementioned rustproof pigments, any one type, or combination of types, selected from among the following may be used, for example: zinc, zinc chromate, strontium chromate, calcium chromate, lead cyanamide, calcium plumbate, zinc phosphate, etc.

Any of the aforementioned pigments may be used in combination as deemed appropriate according to the light transmittance, substrate-concealing property, desired hue, etc., and their appropriate use quantity, from the viewpoints of substrate-concealing property, weather resistance, etc., is such that the light transmittance of the cured coating film to be formed by the base coating material (X) becomes 10 percent or lower, or preferably 5 percent or lower, at wavelengths in a range of 400 to 700 nm.

It should be noted that the light transmittance of the coating material represents the spectral transmittance, measured at wavelengths in a range of 400 to 700 nm using a self-recording spectrophotometer (EPS-3T, manufactured by Hitachi, Ltd.), of a coating film sample obtained by applying the coating material on a glass plate to a prescribed film thickness based on cured coating film, curing the coating material, immersing the glass plate in hot water of 60 to 70° C., and then separating and drying the coating film. If the result varies depending on the measuring wavelength (400 to 700 nm), the maximum value is taken as the light transmittance.

The base coating material (X) is such that, if the base coating material (X) is colored, its black-and-white concealing film thickness is preferably 40 μm or less, or more preferably 5 to 35 μm, or yet more preferably 10 to 30 μm, from the viewpoint of color stability, etc. In this Specification, the “black-and-white concealing film thickness” represents a value determined as follows: a concealing ratio test paper bearing black-and-white checkered patterns as specified in 4.1.2 of JIS K5600-4-1 is attached to a steel plate and then coated inclinedly with the coating material so that the film thickness changes continuously, followed by drying or curing, and then by visual observation of the coated surface under diffused daylight, the minimum film thickness that causes the black-and-white borders of the checkered patterns to disappear on the concealing ratio test paper is measured with an electromagnetic film thickness meter.

If the base coating material (X) is to use any of the aforementioned pigments, the pigment(s) will be used by the necessary quantity according to the purpose, etc. Desirably this quantity is 0.01 to 70 parts by mass, or preferably 0.1 to 50 parts by mass, or more preferably 0.2 to 40 parts by mass, relative to 100 parts by mass (in solids content) of the base coating material (X).

In this case, the solids content of the base coating material (X) is 10 to 60 percent by mass, while its viscosity is 200 to 5000 mPa·s based on the viscosity measured with a type-B viscometer after 1 minute at 6 rpm at a temperature of 20° C. In this Specification, the “LVDV-I” (product name, manufactured by Brookfield Engineering Laboratories, Inc.) was used as a type-B viscometer.

### <Application of Base Coating Material (X)>

The base coating material (X) may be applied according to any standard method, and if the base coating material (X) is an aqueous coating material, this can be done, for example, by adding deionized water, and other additives such as thickening agent and defoaming agent as necessary, to the base coating material (X) to adjust its solids content and viscosity, and then spray-coating, rotary-atomization-coating or otherwise applying it on the surface of the aforementioned coating target. At the time of application, static electricity may be applied as necessary.

The cured film thickness of the base coating film obtained by the base coating material (X) is 0.1 to 35 μm, or preferably 5 to 30 μm, or more preferably 10 to 25 μm, from the viewpoints of light transmittance, substrate-concealing property, photoluminescence, etc.

### [1-2. Step (2)]

Step (2) is a step to apply a photoluminescent pigment dispersion (Y), after the base coating film has been formed in Step (1), to form a photoluminescent coating film.

It should be noted that, for example, a step to apply a colorless transparent coating material, colored transparent coating material, photoluminescent transparent coating material, colored photoluminescent transparent coating material, colored coating material, colored photoluminescent coating material, etc., to form a desired coating film may be provided, or a step to set and/or preheat and/or cure the photoluminescent coating film, may be provided, as necessary, between Step (1) and Step (2).

### <Photoluminescent Pigment Dispersion (Y)>

The photoluminescent pigment dispersion (Y) contains water and a scaly photoluminescent pigment (A).

Also, the photoluminescent pigment dispersion (Y) may contain a viscosity-adjusting agent (B) and/or surface conditioner (C), as necessary.

Preferably the photoluminescent pigment dispersion (Y) contains the aforementioned viscosity-adjusting agent (B) and surface conditioner (C) from the viewpoint of obtaining a multilayer coating film having a less grainy feel and excellent metallic gloss.

### (Scaly Photoluminescent Pigment (A))

As the scaly photoluminescent pigment (A), any one type, or combination of two or more types, may be selected from among light-reflective pigments and light-interference pigments, and used, as deemed appropriate.

The thickness T, which refers to the average thickness, of the scaly photoluminescent pigment (A) is 1 to 65 nm, or preferably 5 to 60 nm, or more preferably 10 to 50 nm.

For use as the scaly photoluminescent pigment (A), scaly photoluminescent pigments whose thickness T is less than 1 nm are difficult to obtain, while those thicker than 65 nm present difficulty obtaining a multilayer coating film having a less grainy feel and excellent metallic gloss.

The average grain size of the scaly photoluminescent pigment (A), while it varies according to the type of scaly photoluminescent pigment (A), is between 0.1 and 100 μm, normally 0.1 to 50 μm, or preferably 1.0 to 23 μm, or more preferably 5.0 to 20 μm.

The average thickness is defined as the average value of at least 100 measured values that have been measured by observing a coating film cross-section, which includes the scaly photoluminescent pigment (A), using a transmission electron microscope (TEM).

The average grain size refers to the median diameter in a volume-based granularity distribution measured according to the laser diffraction/scattering method using the granularity distribution measuring device Microtrac MT3300 (product name, manufactured by Nikkiso Co., Ltd.)

The scaly photoluminescent pigment (A) may specifically be a light-reflective pigment such as scaly metal pigment based on aluminum, copper, chrome, nickel alloy, stainless steel, etc., scaly metal pigment whose surface is coated with a metal oxide, or scaly metal pigment with a colored pigment chemically adsorbed or bonded onto its surface, or a light-interference pigment such as metal oxide-coated mica pigment, metal oxide-coated alumina flake pigment, metal oxide-coated glass flake pigment, metal oxide-coated silica flake pigment, and the like.

The scaly photoluminescent pigment (A) only needs to have a thickness T of 1 to 65 nm, and its manufacturing method, etc., are not limited in any way.

If a light-reflective pigment is used as the scaly photoluminescent pigment (A), a vapor-deposited metal flake pigment may be suitably used from the viewpoints of availability, grainy feel, and finish quality.

A vapor-deposited metal flake pigment is obtained by vapor-depositing a metal film onto a base material, separating the base material, and then pulverizing the vapor-deposited metal film. The aforementioned base material may be, for example, a film, etc.

The aforementioned metal material is not limited in any way, but it may be, for example, aluminum, gold, silver, copper, brass, titanium, chrome, nickel, nickel chrome, stainless steel, etc. Among these, aluminum or chrome is suitable, particularly from the viewpoints of availability, ease of handling, etc. In this Specification, vapor-deposited metal flake pigments obtained by vapor-depositing aluminum are referred to as “vapor-deposited aluminum flake pigments,” while vapor-deposited metal flake pigments obtained by vapor-depositing chrome are referred to as “vapor-deposited chrome flake pigments.”

Commercial products that can be used as the aforementioned vapor-deposited aluminum flake pigment include, for example, the “Hydroshine WS” series (product name, manufactured by Eckart GmbH), “Decomet” series (product name, manufactured by Carl Schlenk AG), “Metasheen” series (product name, manufactured by BASF SE), etc.

Commercial products that can be used as the aforementioned vapor-deposited chrome flake pigment include, for example, the “Metalure Liquid Black” series (product name, manufactured by Eckart GmbH), etc.

The average primary grain size (D50) of the aforementioned vapor-deposited metal flake pigment is 0.1 to 50 μm, or preferably 1 to 23 μm, or particularly preferably 5 to 20 μm, from the viewpoints of stability in the coating material, color tone of the formed coating film, finish quality, etc.

If a vapor-deposited aluminum flake pigment is used as the aforementioned vapor-deposited metal flake pigment, preferably the surface of the vapor-deposited aluminum flake pigment has been treated with silica from the viewpoint, for example, of obtaining a coating film offering excellent storage stability and photoluminescence.

For the scaly photoluminescent pigment (A), a scaly aluminum pigment manufactured by pulverizing or grinding aluminum in a ball mill or attritor mill in the presence of a liquid pulverization medium using a pulverization aid may be used. Here, for the pulverization aid, oleic acid, stearic acid, isostearic acid, lauric acid, palmitic acid, myristic acid, or other higher fatty acid, or aliphatic amine, aliphatic amide, aliphatic alcohol, etc., may be used. For the liquid pulverization medium, mineral spirits or other aliphatic hydrocarbon may be used.

Scaly aluminum pigments are largely classified into the leafing type and the non-leafing type based on the type of pulverization aid. When compounded into a coating material composition, a leafing-type scaly aluminum pigment creates arrays of scales (leafing) on the surface of the obtained coating film to achieve a distinctly metallic finish, assume thermal reflex, and demonstrate rustproofing power; however, caution is required when this type of scaly aluminum pigment is used because, depending on the compounded quantity, it may completely conceal the surface due to the effect of surface tension of the pulverization aid, and allow the coating film to separate easily during the coating film forming process. In this sense, preferably a non-leafing-type scaly aluminum pigment is used.

If a light reflective-pigment is to be used as the scaly photoluminescent pigment (A), preferably one or more types selected from among vapor-deposited aluminum flake pigments, vapor-deposited chrome flake pigments, vapor-deposited aluminum flake pigments whose surface is treated with silica, non-leafing aluminum flake pigments, and non-leafing aluminum flake pigments whose surface is treated with silica, may be used.

If a light-interference pigment is to be used as the scaly photoluminescent pigment (A), specifically a pigment obtained by coating with a metal oxide a semi-opaque base material such as natural mica, artificial mica, alumina flakes, silica flakes, glass flakes, etc., may be used.

The aforementioned light-interference pigment may have been surface-treated to improve dispersibility, water resistance, chemical resistance, weather resistance, etc.

Metal oxide-coated mica pigments are pigments comprising natural mica or artificial mica as a base material, with a metal oxide coated on the surface of the base material.

Natural mica is a scaly base material comprising pulverized mineral mica, while artificial mica, which is synthesized by heating and melting SiO₂, MgO, Al₂O₃, K₂SiF₆, Na₂SiF₆, or other industrial material at a high temperature of approx. 1500° C. and then cooling and crystalizing the molten material, contains fewer impurities and is more uniform in size and thickness than natural mica.

To be specific, fluorine-based mica (KMg₃AlSi₃O₁₀F₂), potassium tetrasilicon mica (KMg_{2.5}AlSi₄O₁₀F₂), sodium tetrasilicon mica (NaMg_{2.5}AlSi₄O₁₀F₂), Na-taeniolite (NaMg₂Li Si₄O₁₀F₂), LiNa-taeniolite (LiNaMg₂LiSi₄O₁₀F₂), etc., are known.

The coating metal oxide may be titanium oxide, iron oxide, aluminum oxide, etc. The coating metal oxide allows for expression of coherent colors.

Metal oxide-coated alumina flake pigments are pigments comprising alumina flakes as a base material, with a metal oxide coated on the surface of the base material. Alumina flakes refer to scales (slivers) of aluminum oxide that are colorless and transparent. Aluminum oxide need not be the only component, and oxides of other metals may also be contained. The coating metal oxide may be titanium oxide or iron oxide. The coating metal oxide allows for expression of coherent colors.

Metal oxide-coated silica flake pigments are pigments comprising scaly silica as a base material having a smooth surface and uniform thickness, which is coated with a metal oxide whose refractive index is different from that of the base material. The coating metal oxide may be titanium oxide, iron oxide, aluminum oxide, etc. The coating metal oxide allows for expression of coherent colors.

Metal oxide-coated glass flake pigments are pigments comprising a scaly glass base material coated with a metal oxide, where the base material with a smooth surface reflects light strongly and thus creates a grainy feel. The coating metal oxide may be titanium oxide or iron oxide. The coating metal oxide allows for expression of coherent colors.

In terms of size, among light-interference pigments whose base material is natural mica, artificial mica, alumina flakes, or silica flakes, those with an average grain size in a range of 5 to 30 μm, or particularly 7 to 25 μm, may be suitably used from the viewpoints of finish quality and grainy feel of the coating film.

Among light-interference pigments whose base material is glass flakes, those with an average grain size in a range of 15 to 100 μm, or particularly 17 to 45 μm, may be suitably used from the viewpoint of grainy feel of the coating film.

If the average grain size exceeds the aforementioned upper-limit value, the multilayer coating film may feel excessively grainy due to the light-interference pigment, which is not desired in terms of design; if it is below the lower-limit value, on the other hand, the luminance may become insufficient.

If a light-interference pigment is to be used as the scaly photoluminescent pigment (A), preferably one or more types selected from among metal oxide-coated mica pigments, metal oxide-coated alumina flake pigments, metal oxide-coated glass flake pigments, and metal oxide-coated silica flake pigments, may be used.

The photoluminescent pigment dispersion (Y) may contain the aforementioned scaly photoluminescent pigment (A) by 0.2 to 80 parts by mass, or particularly 0.5 to 25 parts by mass, or preferably 0.7 to 20 parts by mass, relative to 100 parts by mass (in solids content) of the photoluminescent pigment dispersion from the viewpoint of obtaining a multilayer coating film offering excellent photoluminescence.

### (Viscosity-Adjusting Agent (B))

The viscosity-adjusting agent (B) in the photoluminescent pigment dispersion (Y) may be, for example, a silica-based fine powder, mineral-based viscosity-adjusting agent, atomized barium sulfate powder, polyamide-based viscosity-adjusting agent, viscosity-adjusting agent based on fine organic resin grain, diurea-based viscosity-adjusting agent, urethane-associated type viscosity-adjusting agent, acrylic-swelling type polyacrylic acid-based viscosity-adjusting agent, cellulose-based viscosity-adjusting agent, etc., although any known viscosity-adjusting agent can be used. Among these, use of a mineral-based viscosity-adjusting agent, polyacrylic acid-based viscosity-adjusting agent, or cellulose-based viscosity-adjusting agent is particularly preferred from the viewpoint of obtaining a coating film offering excellent photoluminescence.

Mineral-based viscosity-adjusting agents include swelling laminar silicate salts whose crystalline structure has a 2:1 type structure. To be specific, they include natural or synthetic montmorillonite, saponite, hectorite, stevensite, beidellite, nontronite, bentonite, laponite, and other smectite-family clay minerals, Na-tetrasilicic fluorine mica, Li-tetrasilicic fluorine mica, Na salt-fluorine taeniolite, Li-fluorine tainiolite, and other swelling mica-family clay minerals, vermiculite, substitutes, and derivatives thereof, as well as mixtures thereof.

Polyacrylic acid-based viscosity-adjusting agents include sodium polyacrylate, polyacrylic acid-(meth)acrylic acid ester copolymers, etc.

The acid value of the active ingredient in any such polyacrylic acid-based viscosity-adjusting agent is in a range of 30 to 300 mgKOH/g, or preferably 80 to 280 mgKOH/g.

Commercial products of polyacrylic acid-based viscosity-adjusting agents include, for example, “PRIMAL ASE-60,” “PRIMAL TT615,” and “PRIMAL RM5” (product names) manufactured by Dow Chemical Company, “SN-THICKENER 613,” “SN-THICKENER 618,” “SN-THICKENER 630,” “SN-THICKENER 634,” and “SN-THICKENER 636” (product names) manufactured by San Nopco Limited, etc.

Cellulose-based viscosity-adjusting agents include, for example, carboxy methyl cellulose, methyl cellulose, hydroxy ethyl cellulose, hydroxy ethyl methyl cellulose, hydroxy propyl methyl cellulose, cellulose nanofibers, etc., among which use of cellulose nanofibers is preferred from the viewpoint of obtaining a coating film offering excellent photoluminescence.

The aforementioned cellulose nanofibers are also referred to as “cellulose nanofibril,” “fibrillated cellulose,” or “nanocellulose crystal.”

As for the aforementioned cellulose nanofibers, the number-average fiber diameter is in a range of preferably 2 to 500 nm, or more preferably 2 to 250 nm, or yet more preferably 2 to 150 nm, from the viewpoint of obtaining a coating film offering excellent photoluminescence. Also, the number-average fiber length is in a range of preferably 0.1 to 20 μm, or more preferably 0.1 to 15 μm, or yet more preferably 0.1 to 10 μm.

The aforementioned number-average fiber diameter and number-average fiber length are measured and calculated, for example, from an image obtained by dispersion-treating a water-diluted sample of cellulose nanofibers, casting the dispersed sample on a carbon film-coated grid that has been hydrophilization-treated, and then observing the cast sample with a transmission electron microscope (TEM).

For the aforementioned cellulose nanofibers, those obtained by fibrillating cellulose materials and stabilizing the fibrillated fibers in water, may be used.

Here, cellulose materials refer to materials of various forms that are substantially cellulose, and specifically include, for example: pulp (wood pulp, jute, Manilla hemp, kenaf, and other types of plant-derived pulp, etc.); bacteria-produced cellulose and other types of natural cellulose; regenerated cellulose obtained by dissolving cellulose in a copper ammonium solution, morpholine derivative, or other solvent, followed by spinning; fine cellulose obtained by hydrolyzing, alkali-hydrolyzing, enzyme-degrading, blast-treating, vibration-ball-milling, or otherwise mechanically treating the aforementioned cellulose materials and thereby depolymerizing the cellulose; etc.

Also, water dispersion liquids obtained by anion-modifying a cellulose material using any known method, followed by application of various treatments and dispersion in an aqueous solvent, may be used. For example, cellulose nanofibers obtained by introducing carboxyl groups, carboxymethyl groups, phosphoric acid groups, or other groups to a cellulose material using any known method, washing the obtained modified cellulose to prepare a modified-cellulose dispersion liquid, and then applying mechanical shearing forces to the dispersion liquid to achieve fibrillation, may be used.

Commercial products of cellulose nanofibers include, for example, Rheocrysta (registered trademark) manufactured by Dai-ichi Kogyo Seiyaku Co., Ltd., for example. Under the present invention, cellulose nanofibers prepared as below may be used, for example.

The aforementioned cellulose nanofibers may be manufactured according to the method below, for example.

Although how the aforementioned cellulose materials should be fibrillated is not limited in any way so long as the cellulose materials remain in fiber state, the methods include, for example, mechanical fibrillation treatment using a homogenizer, grinder, etc., chemical treatment using an oxidation catalyst, etc., biological treatment using bacteria, etc.

Also, for the aforementioned cellulose nanofibers, anion-modified cellulose nanofibers may also be used. Anion-modified cellulose nanofibers include, for example, carboxylated cellulose nanofibers, carboxymethylated cellulose nanofibers, phosphoric acid group-containing cellulose nanofibers, etc. The aforementioned anion-modified cellulose nanofibers may be obtained, for example, by introducing carboxyl groups, carboxymethyl groups, or other functional groups to a cellulose material using any known method, washing the obtained modified cellulose to prepare a modified-cellulose dispersion liquid, and then fibrillating this dispersion liquid. The aforementioned carboxylated cellulose is also referred to as “oxidized cellulose.”

The aforementioned oxidized cellulose may be obtained by oxidizing any of the aforementioned cellulose materials, using an oxidizing agent in water, in the presence of a compound selected from the group that includes N-oxyl compounds, bromides, iodides, and mixtures thereof.

The use quantity of N-oxyl compound is not limited in any way so long as the catalyst quantity is sufficient to convert the cellulose into nanofibers. The use quantity of bromide or iodide may be selected as deemed appropriate to the extent that oxidation reaction can be promoted.

For the aforementioned oxidizing agent, any known oxidizing agent may be used, and, for example, halogen, hypohalous acid, halogenous acid, perhalogen acid, or salt thereof, halogen oxide, or peroxide, etc., may be used. Preferably the conditions are set so that the quantity of carboxyl groups in the oxidized cellulose becomes 0.2 mmol/g or greater relative to the mass in solids content of the oxidized cellulose. The quantity of carboxyl groups can be adjusted by: adjusting the oxidation reaction time; adjusting the oxidation reaction temperature; adjusting the oxidation reaction pH; adjusting the additive quantities of N-oxyl compound, bromide, iodide, oxidizing agent, etc., and the like.

The aforementioned carboxymethyl groups may be introduced as below.

The aforementioned cellulose material is mixed with a solvent and then mercerization-treated at a reaction temperature of 0 to 70° C. for a reaction period of 15 minutes to 8 hours by using, as a mercerization agent, an alkali metal hydroxide of 0.5 to 20 times by mol in quantity per glucose residue from the cellulose material. Thereafter, a carboxymethylation agent is added by a quantity of 0.05 to 10.0 times by mol per glucose residue and then reacted at a reaction temperature of 30 to 90° C. for a reaction period of 30 minutes to 10 hours, thereby allowing carboxymethyl groups to be introduced to the hydroxyl groups in the cellulose molecules.

Preferably the degree of carboxymethyl substitution per unit glucose in the modified cellulose obtained by introducing carboxymethyl groups to the aforementioned cellulose material, is 0.02 to 0.50.

The modified cellulose obtained as above may be turned into a dispersion liquid in an aqueous solvent and then fibrillated using a pulverizer. As for the pulverizer to be used, a pulverizer of any type such as the high-speed shearing type, collision type, bead-mill type, high-speed rotary type, colloid-mill type, high-pressure type, roll-mill type, or ultrasonic type, may be used. Also, multiple of these pulverizers may be used in combination. Among these, use of a fibrillation device of high-speed shearing type, collision type, or high-speed rotary type is preferred from the viewpoint of allowing a treatment with stronger shearing forces under conditions where the risk of contamination by the medium is low.

Any of these viscosity-adjusting agents may be used alone, or two or more types may be used in combination as deemed appropriate.

### (Surface Conditioner (C))

Preferably the photoluminescent pigment dispersion (Y) further contains a surface conditioner (C). The surface conditioner is used to facilitate uniform orientation of the scaly photoluminescent pigment (A) dispersed in water, on the coating target, when the photoluminescent pigment dispersion (Y) is applied on the coating target. Once the scaly photoluminescent pigment (A) can be oriented uniformly on the coating target, a multilayer coating film having a less grainy feel and excellent metallic gloss can be obtained.

Preferably the surface conditioner (C) is such that, when isopropanol, water, and the surface conditioner (C) are mixed at ratios of 4.5/95/1, and the resulting liquid is adjusted to a viscosity of 150 mPa·s on a type-B viscometer at a rotor speed of 60 rpm and then dripped by 10 μL onto a pre-degreased tin sheet (manufactured by Paltech Corporation), the contact angle of the liquid to the tin sheet, measured after 10 seconds, becomes 8 to 20°, or preferably 9 to 19°, or more preferably 10 to 18°. Here, the “ASE-60” viscosity-adjusting agent (polyacrylic acid-based viscosity-adjusting agent, manufactured by Dow Chemical Company, solids content: 28 percent) is used for adjustment of viscosity.

The isopropanol/water/surface conditioner (C) ratios of 4.5/95/1 correspond to the ratios of the components in the photoluminescent pigment dispersion (Y) used for evaluating the surface conditioner (C). The viscosity of 150 mPa·s on a type-B viscometer at a rotor speed of 60 rpm represents a normal value for application on coating targets. Also, the aforementioned contact angle of 8 to 20° to the tin sheet indicates how the liquid would wet and spread under standard application conditions. If the contact angle is 8° or greater, the liquid will be applied on the coating target without spreading too much; if it is 20° or smaller, on the other hand, the liquid will be applied uniformly on the coating target without repelling too much.

The surface conditioner (C) may be, for example, any of silicone-based, acetylenediol-based, acrylic-based, vinyl-based, fluorine-based, and other surface conditioners (C). Any of the aforementioned surface conditioners (C) may be used alone, or two or more types may be used in combination as deemed appropriate.

Commercial products of surface conditioners (C) include, for example, the BYK series manufactured by BYK-Chemie GmbH, Tego series, Surfynol series, and Dynol series manufactured by Evonik Industries AG, Granol series and Polyflow series manufactured by Kyoeisha Chemical Co., Ltd., and Disparlon series manufactured by Kusumoto Chemicals, Ltd., etc.

Among the surface conditioners (C), silicone-based surface conditioners or acetylenediol-based surface conditioners are preferred from the viewpoints of metallic gloss and water resistance of the obtained coating film, for example. As for silicone-based surface conditioners, polydimethylsiloxane and modified silicones obtained by modifying polydimethylsiloxane are used. Modified silicones include polyether-modified products, acrylic-modified products, polyester-modified products, etc. Acetylenediol-based surface conditioners include those obtained by adding alkylene oxides to acetylenediols, for example.

For the surface conditioner (C), one whose dynamic surface tension is preferably 50 to 70 mN/m, or more preferably 53 to 68 mN/m, or yet more preferably 55 to 65 mN/m, may be used. In this Specification, the dynamic surface tension refers to the value of surface tension at a frequency of 10 Hz according to the maximum bubble pressure method.

The dynamic surface tension is measured using a SITA measuring device (SITA t60 manufactured by EKO Instruments Co., Ltd.).

Also, for the surface conditioner (C), one whose static surface tension is preferably 15 to 30 mN/m, or more preferably 18 to 27 mN/m, or yet more preferably 20 to 24 mN/m, may be used.

The static surface tension is measured using a surface tension measuring machine (DCAT 21 manufactured by EKO Instruments Co., Ltd.).

Furthermore, for the surface conditioner (C), one whose lamellar length is preferably 6.0 to 9.0 mm, or more preferably 6.5 to 8.5 mm, or yet more preferably 7.0 to 8.0 mm, may be used.

The photoluminescent pigment dispersion (Y) may contain a base resin, and a crosslinking agent, from the viewpoint of adhesion property of the obtained coating film.

The aforementioned base resin may be acrylic resin, polyester resin, alkyd resin, urethane resin, etc. These may be water-based dispersions or solutions.

The aforementioned crosslinking agent may be melamine resin, melamine resin derivative, urea resin, (meth)acrylamide, polyaziridine, polycarbodiimide, blocked or unblocked polyisocyanate compound, etc. Any of these may be used alone, or two or more types may be used in combination.

Furthermore, pH adjusters, organic solvents, colored pigments, extender pigments, photoluminescent pigments other than the scaly photoluminescent pigment (A), pigment dispersants, anti-settling agents, defoaming agents, UV absorbents, etc., may be compounded, as deemed appropriate, into the photoluminescent pigment dispersion (Y) as necessary.

As for pH adjusters to be compounded into the photoluminescent pigment dispersion (Y) as necessary, specifically those that are normally used in coating materials may be used.

Any of inorganic acids, inorganic bases, organic acids, and organic bases may be used as pH adjusters. Any of these may be used alone, or two or more types may be used in combination.

As for organic solvents to be compounded into the photoluminescent pigment dispersion (Y) as necessary, specifically those that are normally used in coating materials may be used.

Organic solvents include, for example, the same organic solvents that are compounded into the aforementioned base coating material (X) as necessary. Any of these may be used alone, or two or more types may be used in combination.

In terms of the content in the photoluminescent pigment dispersion (Y), an organic solvent(s) may be contained by 0 to 40 parts by mass, or particularly 0 to 30 parts by mass, or preferably 0 to 20 parts by mass, relative to 100 parts by mass of the photoluminescent pigment dispersion.

As for colored pigments to be compounded into the photoluminescent pigment dispersion (Y) as necessary, any one type, or combination of two or more types, of conventionally known pigments used for inks, coating materials or coloring of plastics may be contained, for example.

The aforementioned colored pigments include, for example, the same colored pigments that are compounded into the aforementioned base coating material (X) as necessary. By using any of these alone or a combination of two or more types, a desired color tone can be achieved.

The aforementioned extender pigments include, for example, barium sulfate, barium carbonate, calcium carbonate, aluminum silicate, silica, magnesium carbonate, talc, alumina white, etc.

### (Compounding Quantity of Each Component in Photoluminescent Pigment Dispersion (Y))

The photoluminescent pigment dispersion (Y) contains water and a scaly photoluminescent pigment (A). In the photoluminescent pigment dispersion (Y), desirably the compounding ratio of each component is within the following ranges, relative to 100 parts by mass of the total quantity of water and scaly photoluminescent pigment (A), from the viewpoint of obtaining a coating film offering excellent photoluminescence:

water: 70 to 99.999 parts by mass, or preferably 80 to 99.999 parts by mass, or yet more preferably 90 to 999.995 parts by mass; and

scaly photoluminescent pigment (A): 30 to 0.001 parts by mass, or preferably 20 to 0.001 parts by mass, or yet more preferably 10 to 0.005 parts by mass (mass in solids content).

If the photoluminescent pigment dispersion (Y) contains a viscosity-adjusting agent (B), the viscosity-adjusting agent (B) may be contained by 0.1 to 50 parts by mass, or particularly by 1 to 35 parts by mass, or preferably by 5 to 25 parts by mass, in solids content, relative to 100 parts by mass (in solids content) of the photoluminescent pigment dispersion, from the viewpoint of obtaining a multilayer coating film offering excellent photoluminescence.

Also, if the viscosity-adjusting agent (B) contains a cellulose-based viscosity-adjusting agent, the content of the cellulose-based viscosity-adjusting agent is preferably in a range of 2 to 100 parts by mass, or more preferably in a range of 5 to 70 parts by mass, or particularly preferably in a range of 8 to 60 parts by mass, in solids content, based on the photoluminescent pigment dispersion representing 100 parts by mass (in solids content), from the viewpoint of obtaining a multilayer coating film offering excellent photoluminescence.

If the photoluminescent pigment dispersion (Y) contains a surface conditioner (C), the surface conditioner (C) may be contained by 1 to 50 parts by mass, or particularly 5 to 45 parts by mass, or preferably 8 to 40 parts by mass, in solids content, relative to 100 parts by mass (in solids content) of the photoluminescent pigment dispersion, from the viewpoint of obtaining a multilayer coating film offering excellent photoluminescence.

### (Application of Photoluminescent Pigment Dispersion (Y))

The photoluminescent pigment dispersion (Y) is prepared by mixing and dispersing the aforementioned components.

From the viewpoint of obtaining a coating film offering excellent photoluminescence, desirably the ratio of solids content at application is adjusted to 0.1 to 15 percent by mass, or preferably 0.2 to 10 percent by mass, based on the photoluminescent pigment dispersion (Y).

Suitably the viscosity of the photoluminescent pigment dispersion (Y) is such that, from the viewpoint of obtaining a coating film offering excellent photoluminescence, the viscosity measured with a type-B viscometer after 1 minute at 60 rpm at a temperature of 20° C. (also referred to as “B60 value” in this Specification) is 60 to 1500 mPa·s, or preferably 60 to 1000 mPa·s, or yet more preferably 60 to 500 mPa·s. Here, the viscometer used is the LVDV-I (product name, type-B viscometer manufactured by Brookfield Engineering Laboratories, Inc.)

The photoluminescent pigment dispersion (Y) may be applied by electrostatic coating, air spraying, airless spraying, or other method. Under the method for forming multilayer coating film proposed by the present invention, rotary-atomization type electrostatic coating is particularly preferred.

Once applied, preferably the photoluminescent coating film obtained through application of the photoluminescent pigment dispersion (Y) is treated using an appropriate means, such as a method whereby the photoluminescent coating film is let stand for 15 to 30 minutes at room temperature, or a method whereby it is preheated for 30 seconds to 10 minutes at a temperature of 50 to 100° C., for example.

The thickness of the photoluminescent coating film, based on cured film thickness, is preferably 0.02 to 6.5 μm, or more preferably 0.04 to 5.0 μm, or yet more preferably 0.12 to 3.0 μm, or even more preferably 0.12 to 2.0 μm, or most preferably 0.12 to 1.0 μm.

If the film thickness of the photoluminescent coating film is less than 0.02 μm, formation of photoluminescent coating film becomes difficult and also the quantity of photoluminescent pigment contained per unit area of the multilayer coating film decreases and therefore the reflection intensity drops, which is not desired. If the cured film thickness of the photoluminescent coating film exceeds 6.5 μm, the orientation of the photoluminescent pigment drops, which is not desired.

### [1-3. Step (3)]

Step (3) is a step to form a clear coating film on the photoluminescent coating film formed in Step (2), by applying a clear coating material (Z) thereon.

It should be noted that, for example, a step to apply a colorless transparent coating material, colored transparent coating material, photoluminescent transparent coating material, colored photoluminescent transparent coating material, etc., to form a desired coating film may be provided, or a step to set and/or preheat and/or cure the photoluminescent coating film, may be provided, as necessary, between Step (2) and Step (3).

### <Clear Coating Material (Z)>

For the clear coating material (Z), any of known thermosetting clear-coat coating material compositions may be used. Such thermosetting clear-coat coating material compositions include, for example, organic solvent-type thermosetting coating material compositions, aqueous thermosetting coating material compositions, powder thermosetting coating material compositions, etc., each containing a base resin having crosslinkable functional groups and a crosslinking agent.

The crosslinkable functional groups contained in the aforementioned base resin include, for example, carboxyl groups, hydroxyl groups, epoxy groups, silanol groups, etc. The types of base resins include, for example, acrylic resins, polyester resins, alkyd resins, urethane resins, epoxy resins, fluororesins, etc. Crosslinking agents include, for example, polyisocyanate compounds, blocked polyisocyanate compounds, melamine resins, urea resins, carboxyl group-containing compounds, carboxyl group-containing resins, epoxy group-containing resins, epoxy group-containing compounds, etc.

Preferred base resin/crosslinking agent combinations for the clear coating material (Z) include carboxyl group-containing resin/epoxy group-containing resin, hydroxyl group-containing resin/polyisocyanate compound, hydroxyl group-containing resin/blocked polyisocyanate compound, hydroxyl group-containing resin/melamine resin, etc.

Also, the aforementioned clear coating material (Z) may be a one-component type coating material, or it may be a two-component type urethane resin coating material or other multi-component type coating material.

Preferred clear coating materials (Z), from the viewpoint of adhesion property of the obtained coating film, are two-component type clear coating materials, containing a hydroxyl group-containing resin and an isocyanate group-containing compound.

If a two-component type clear coating material containing a hydroxyl group-containing resin and an isocyanate group-containing compound is used as the clear coating material (Z), preferably, in terms of storage stability, it takes a form where the hydroxyl group-containing resin and the polyisocyanate compound are isolated and the two are mixed to prepare the clear coating material immediately before use.

If a one-component type coating material is used as the clear coating material (Z), the base resin/crosslinking agent combination for the one-component type coating material may be carboxyl group-containing resin/epoxy group-containing resin, hydroxyl group-containing resin/blocked polyisocyanate compound, hydroxyl group-containing resin/melamine resin etc. If a one-component type coating material is used as the clear coating material (Z), preferably the clear coating material (Z) contains a self-crosslinking component from the viewpoint of adhesion property.

Self-crosslinking components include melamine resins, melamine resin derivatives, (meth)acrylic amides, polyaziridines, polycarbodiimides, blocked or unblocked polyisocyanates, etc. Any of these may be used alone, or two or more types may be used in combination.

Furthermore, as necessary, water, organic solvents, and other solvents, curing catalysts, defoaming agents, UV absorbents, and other additives may be compounded into the clear coating material (Z) as deemed appropriate.

### (Hydroxyl Group-Containing Resin)

For the hydroxyl group-containing resin, any conventionally known resin may be used without limitation so long as it contains hydroxyl groups. Such hydroxyl group-containing resins include, for example, hydroxyl group-containing acrylic resins, hydroxyl group-containing polyester resins, hydroxyl group-containing polyether resins, hydroxyl group-containing polyurethane resins, etc. Preferred are hydroxyl group-containing acrylic resins and hydroxyl group-containing polyester resins, while particularly preferred are hydroxyl group-containing acrylic resins.

The hydroxyl group value of the hydroxyl group-containing acrylic resin is preferably in a range of 80 to 200 mgKOH/g, or more preferably in a range of 100 to 180 mgKOH/g. A hydroxyl group value of 80 mgKOH/g or higher ensures high crosslinking density and consequently sufficient scratch resistance. Also, a hydroxyl group value of 200 mgKOH/g or lower allows the water resistance of the coating film to be maintained.

The weight-average molecular weight of the hydroxyl group-containing acrylic resin is preferably in a range of 2500 to 40000, or more preferably in a range of 5000 to 30000. A weight-average molecular weight of 2500 or higher ensures good coating film performance in terms of acid resistance, etc., while a weight-average molecular weight of 40000 or lower leads to good finish quality because smoothness of the coating film is maintained.

It should be noted that, in this Specification, the average molecular weight represents the value calculated from a chromatogram measured with a gel permeation chromatograph using the molecular weight of standard polystyrene as a reference. For the gel permeation chromatograph, the “HLC8120GPC” (manufactured by Tosoh Corporation) was used. Chromatography was performed using four columns including the “TSKgel G-4000HXL,” “TSKgel G-3000HXL,” “TSKgel G-2500HXL,” and “TSKgel G-2000HXL” (product names, all manufactured by Tosoh Corporation) under the conditions of tetrahydrofuran mobile phase, measurement temperature of 40° C., flow rate of 1 cc/min, and RI detector.

Preferably the glass transition temperature of the hydroxyl group-containing acrylic resin is in a range of −40 to 20° C., or particularly −30 to 10° C. A glass transition temperature of −40° C. or higher ensures sufficient coating film hardness, while that of 20° C. or lower allows the coated surface smoothness of the coating film to be maintained.

### (Polyisocyanate Compound)

Polyisocyanate compounds are compounds having at least two isocyanate groups in one molecule, including, for example, aliphatic polyisocyanates, alicyclic polyisocyanates, aromatic-aliphatic polyisocyanates, aromatic polyisocyanates, derivatives of these polyisocyanates, etc.

The aforementioned aliphatic polyisocyanate include, for example: trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethyl hexamethylene diisocyanate, diisocyanate dimerate, 2,6-diisocyanatomethyl hexanoate (common name: lysine diisocyanate), and other aliphatic diisocyanates; 2-isocyanatoethyl 2,6-diisocyanatohexanoate, 1,6-diisocyanato-3-isocyanatomethyl hexane, 1,4,8-triisocyanatooctane, 1,6,11-triisocyanatoundecane, 1,8-diisocyanato-4-isocyanatomethyl octane, 1,3,6-triisocyanatohexane, 2,5,7-trimethyl-1,8-diisocyanato-5-isocyanatomethyl octane, and other aliphatic triisocyanates, etc.

The aforementioned alicyclic polyisocyanates include, for example: 1,3-cyclopentane diisocyanate, 1,3-cyclopentene diisocyanate, 1,4-cyclohexane diisocyanate, 1,3-cyclohexane diisocyanate, 3-isocyanatomethyl-3,5,5-trimethyl cyclohexyl isocyanate (common name: isophorone diisocyanate), 4-methyl-1,3-cyclohexylene diisocyanate (common name: hydrogenated TDI), 2-methyl-1,3-cyclohexylene diisocyanate, 1,3- or 1,4-bis(isocyanatomethyl) cyclohexane (common name: hydrogenated xylylene diisocyanate), or mixtures thereof, methylene bis(4,1-cyclohexane diyl) diisocyanate (common name: hydrogenated MDI), norbornane diisocyanate, and other alicyclic diisocyanates; 1,3,5-triisocyanatocyclohexane, 1,3,5-trimethyl isocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)-heptane, 6-(2-isocyanatoethyl)-2-isocyanatomethyl-2-(3-isocyanatopropyl)-bicyclo(2.2.1)heptane, and other alicyclic triisocyanates, etc.

The aforementioned aromatic-aliphatic polyisocyanates include, for example, methylene bis(4,1-phenylene) diisocyanate (common name: MDI), 1,3- or 1,4-xylylene diisocyanate, or mixtures thereof, ω,ω′-diisocyanato-1,4-diethyl benzene, 1,3- or 1,4-bis(1-isocyanato-1-methyl ethyl) benzene (common name: tetramethyl xylylene diisocyanate), or mixtures thereof, and other aromatic-aliphatic diisocyanates; 1,3,5-triisocyanatomethyl benzene and other aromatic-aliphatic triisocyanates, etc.

The aforementioned aromatic polyisocyanates include, for example, m-phenylene diisocyanate, p-phenylene diisocyanate, 4,4′-diphenyl diisocyanate, 1,5-naphthalene diisocyanate, 2,4-tolylene diisocyanate (common name: 2,4-TDI), or 2,6-tolylene diisocyanate (common name: 2,6-TDI), or mixtures thereof, 4,4′-toluidine diisocyanate, 4,4′-diphenyl ether diisocyanate, and other aromatic diisocyanates; triphenyl methane-4,4′,4″-triisocyanate, 1,3,5-triisocyanatobenzene, 2,4,6-triisocyanatotoluene, and other aromatic triisocyanates; 4,4′-diphenyl methane-2,2′,5,5′-tetraisocyanate and other aromatic tetraisocyanates, etc.

Also, the aforementioned derivatives of polyisocyanates include, for example, dimers and trimers of the aforementioned polyisocyanates, biurets, allophanates, uretdiones, uretimines, isocyanurates, oxadiazine-triones, polymethylene polyphenyl polyisocyanates (crude MDI, polymeric MDI), crude TDI, etc.

Any of the aforementioned polyisocyanates and derivatives thereof may be used alone, or two or more types may be used in combination.

Hexamethylene diisocyanate compounds among other aliphatic diisocyanates, as well as 4,4′-methylene bis(cyclohexyl isocyanate) among other alicyclic diisocyanates, may be suitably used. In particular, derivatives of hexamethylene diisocyanates are most suited among the foregoing from the viewpoints of adhesion property, compatibility, etc.

Also, for the aforementioned polyisocyanate compound, prepolymers obtained by reacting the aforementioned polyisocyanates or derivatives thereof, under conditions of excess isocyanate groups, with compounds reactive to such polyisocyanates, such as compounds having hydroxyl groups, amino groups, or other active hydrogen groups, may be used. The compounds reactive to such polyisocyanates include, for example, polyalcohols, low-molecular-weight polyester resins, amines, water, active hydrogen group-containing resins (acryl polyols, polyolefin polyols, polyurethane polyols, polyether polyols, polyester polyols), etc.

Also, for the polyisocyanate compound, blocked polyisocyanate compounds, which are compounds obtained by blocking the isocyanate groups in the aforementioned polyisocyanates, or derivatives thereof using blocking agents, may be used.

The aforementioned blocking agents include, for example; phenol, cresol, xylenol, nitrophenol, ethyl phenol, hydroxydiphenyl, butyl phenol, isopropyl phenol, nonyl phenol, octyl phenol, hydroxymethyl benzoate, and other phenol-based compounds; ε-caprolactam, δ-valerolactam, γ-butyrolactam, β-propiolactam, and other lactam-based compounds; methanol, ethanol, propyl alcohol, butyl alcohol, amyl alcohol, lauryl alcohol, and other aliphatic alcohol-based compounds; ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxymethanol and other ether-based compounds; benzyl alcohol, glycol acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, 2-hydroxyethyl methacrylate, and other alcohol-based compounds; formamide oxime, acetoamide oxime, acetoxime, methyl ethyl ketoxime, diacetyl monoxime, benzophenone oxime, cyclohexane oxime, and other oxime-based compounds; dimethyl malonate, diethyl malonate, ethyl acetoacetate, methyl acetoacetate, acetyl acetone, and other active methylene-based compounds; butyl mercaptan, t-butyl mercaptan, hexyl mercaptan, t-dodecyl mercaptan, 2-mercaptobenzothiazole, thiophenol, methyl thiophenol, ethyl thiophenol, and other mercaptan-based compounds; acetanilide, acetanisidide, acetotoluide, acrylamide, methacrylamide, amide acetate, amide stearate, benzamide, and other acid amide-based compounds; imide succinate, imide phthalate, imide maleate, and other imide-based compounds; diphenylamine, phenyl naphthylamine, xylidine, N-phenyl xylidine, carbazole, aniline, naphthylamine, butylamine, dibutylamine, butyl phenylamine, and other amine-based compounds; imidazole, 2-ethyl imidazole, and other imidazole-based compounds; urea, thiourea, ethylene urea, ethylene thiourea, diphenyl urea, and other urea-based compounds; phenyl N-phenylcarbamate and other carbamic acid ester-based compounds; ethylene imine, propylene imine, and other imine-based compounds; sodium bisulfite, potassium bisulfite, and other sulfite-based compounds; azole-based compounds, etc. The aforementioned azole-based compounds include pyrazole, 3,5-dimethyl pyrazole, 3-methyl pyrazole, 4-benzyl-3,5-dimethyl pyrazole, 4-nitro-3,5-dimethyl pyrazole, 4-bromo-3,5-dimethyl pyrazole, 3-methyl-5-phenyl pyrazole, and other pyrazoles or pyrazole derivatives; imidazole, benzimidazole, 2-methyl imidazole, 2-ethyl imidazole, 2-phenyl imidazole, and other imidazoles or imidazole derivatives; 2-methyl imidazoline, 2-phenyl imidazoline, and other imidazoline derivatives, etc.

Blocking (reaction of blocking agent), if applicable, may be performed by adding solvents as necessary. Ideally solvents used in blocking reaction are not reactive to isocyanate groups, such as acetone, methyl ethyl ketone and other ketones, ethyl acetate, and other esters, N-methyl-2-pyrrolidone (NMP), and other solvents, for example.

Any of these polyisocyanate compounds may be used alone, or two or more types may be used in combination.

If a two-component type clear coating material containing a hydroxyl group-containing resin and an isocyanate group-containing compound is used as the clear coating material (Z), the equivalent ratio of the hydroxyl groups in the hydroxyl group-containing resin and the isocyanate groups in the polyisocyanate compound (NCO/OH) is in a range of preferably 0.5 to 2.0, or more preferably 0.8 to 1.5, from the viewpoints of curability, scratch resistance, etc., of the coating film.

The aforementioned clear coating material (Z) may contain colored pigments, photoluminescent pigments, extender pigments, and other pigments, dyes, etc., as deemed appropriate to the extent that transparency is not reduced.

For the aforementioned colored pigments, any one type, or combination of two or more types of pigments conventionally known for use in inks and coating materials may be used.

For such colored pigments, those colored pigments that may be used in the aforementioned base coating material (X) can be used.

For the aforementioned photoluminescent pigments, those that are conventionally known may be used.

For such photoluminescent pigments, those photoluminescent pigment types that are used in the aforementioned photoluminescent pigment dispersion (Y) and have arbitrary thickness can be used. In particular, use of light-interference pigments is preferred.

Specifically, for the aforementioned dyes, any one type, or combination of more types, selected from among azo-based dyes, triphenyl methane-based dyes, and other dyes offering excellent weather resistance, may be used.

If the clear coating material (Z) contains a pigment, the additive quantity of the pigment, although it may be determined as deemed appropriate, is preferably 10 parts by mass or lower, or more preferably 0.01 to 5 parts by mass, relative to 100 parts by mass of the solids resin content in the clear coating material (Z).

Although the form of the clear coating material (Z) is not limited in any way, it is normally used as a coating material composition of organic solvent type. Organic solvents that may be used in this case include various organic solvents for coating materials; for example, aromatic or aliphatic hydrocarbon-based solvents, ester-based solvents, ketone-based solvents, ether-based solvents, etc., may be used. The organic solvents to be used may be those used in the preparation of the hydroxyl group-containing resin, etc., used as is or may further be added as deemed appropriate.

The concentration, in solids content, of the clear coating material (Z) is preferably in a range of 30 to 70 percent by mass, or more preferably 40 to 60 percent by mass.

After the aforementioned photoluminescent coating film has been formed, the aforementioned clear coating material (Z) is applied on the photoluminescent coating film or on an arbitrary coating film provided on the photoluminescent coating film.

Application of the clear coating material (Z) is not limited in any way and can be performed using the same methods employed for base-coat coating materials. For example, it can be performed by air spraying, airless spraying, rotary atomization coating, curtain coating, or other application methods. These application methods may be combined with electrostatic impression, as necessary. Among the foregoing, rotary atomization coating under electrostatic impression is preferred.

Preferably the application quantity of the clear coating material (Z) is a quantity that typically provides a cured film thickness of 10 to 50 μm.

If the cured film thickness of the clear coating film is less than 15 μm, the surface smoothness would drop, which is not desired. If the cured film thickness of the clear coating film exceeds 50 μm, on the other hand, the clear coating film would drip when applied and the surface smoothness would drop as a result, which is not desired.

Before applying the clear coating material (Z), preferably the viscosity of the clear coating material (Z) is adjusted as deemed appropriate, using organic solvents or other solvents, to a viscosity range suitable for the application method, such as to a viscosity range of 15 to 60 seconds as measured by a Ford Cup No. 4 viscometer at 20° C. in the case of rotary atomization coating under electrostatic impression.

Once the clear coating material (Z) has been applied and a clear coating film has been formed, it may be preheated for 3 to 10 minutes at a temperature of 50 to 80° C., for example, to promote the volatilization of volatile components.

The aforementioned clear coating film may have one layer, or it may have two or more layers. If the clear coating film has two or more layers, the first layer and the second layer may be constituted by the same clear coating material (Z) or different clear coating materials (Z). If different clear coating materials (Z) are used, preferably a clear coating material (Z1) containing a hydroxyl group-containing acrylic resin and a melamine resin is used as the clear coating material for the first layer, while a clear coating material (Z2) containing a hydroxyl group-containing acrylic resin and a polyisocyanate compound is used as the clear coating material for the second layer, from the viewpoints of smoothness and adhesion property of the obtained coating material.

### [Formation of Multilayer Coating Film]

For the method for forming a multilayer coating film, any known means may be adopted.

The specifics are described below.

On top of a coating target that has been degreased and/or surface-treated (phosphate-treated, chromate-treated, complex-oxide-treated, etc.) as necessary, at least one layer of coating film of at least one type, such as electrodeposition coating film (cationic electrodeposition coating film, anionic electrodeposition coating film), primer coating film, colored middle-coat coating film, transparent middle-coat coating film, etc., is formed as necessary.

Next, a base coating film of desired color tone is formed in Step (1).

Next, at least one layer of coating film of at least one type, such as colorless transparent coating film, colored transparent coating film, photoluminescent transparent coating film, colored photoluminescent transparent coating film, colored coating film, colored photoluminescent coating film, etc., is formed as necessary.

Next, a photoluminescent coating film is formed in Step (2).

Next, at least one layer of coating film of at least one type, such as colorless transparent coating film, colored transparent coating film, photoluminescent transparent coating film, colored photoluminescent transparent coating film, colored coating film, colored photoluminescent coating film, etc., is formed as necessary.

Next, a clear coating film is formed in Step (3).

If desired, at least one layer of top clear coating film, etc., is formed on the clear coating film that was formed in Step (3), and now a multilayer coating film is formed.

When forming a coating film on a coating film, a coating film may be formed on a wet coating film, or a coating film may be formed on a coating film that has been set and/or preheated and/or cured.

When forming coating films, each coating film may be heated and cured after it has been formed, or any multiple uncured coating films may be simultaneously heated to simultaneously form multiple cured coating films.

A step in which multiple layers of uncured coating films including the uncured base coating film, uncured photoluminescent coating film, and uncured clear coating film formed in Steps (1) to (3) are heated to simultaneously cure these three coating films, is preferred. It should be noted that, even when the photoluminescent pigment dispersion (Y) does not contain the aforementioned base resin and crosslinking agent, the photoluminescent coating film may still cure due to migration of resin components from the top layer and/or bottom layer.

Heating as part of coating film formation can be performed by any known means, where, for example, a hot air furnace, electric furnace, infrared induction heating furnace, or other drying furnace may be used.

It is appropriate that the heating temperature, while not limited in any way, is in a range of 70 to 150° C., or preferably 80 to 140° C.

The heating period, while not limited in any way, is in a range of preferably 10 to 40 minutes, or more preferably 20 to 30 minutes.

A multilayer coating film is formed by performing Steps (1) to (3) above in this order.

The obtained multilayer coating film is such that the thickness T of the scaly photoluminescent pigment (A) contained in the photoluminescent pigment dispersion (Y), and the area occupancy ratio R indicating how much of the surface of the multilayer coating film is occupied by the parts in which the photoluminescent pigment is projected when all photoluminescent pigment present in the multilayer coating film is projected onto the surface of the multilayer coating film, satisfy Requirement (1) below:

T (nm)×R (%)≤2000 (1)

Under the present invention, the thickness T of the aforementioned scaly photoluminescent pigment (A) is 1 to 65 nm, while the aforementioned area occupancy ratio R is 0.1 to 50 percent.

When the product of the aforementioned T (nm) and R (%) is 2000 or smaller (TxR≤2000), a metallic coating film having a less grainy feel and excellent metallic gloss can be formed on a coating target.

The thickness T of the scaly photoluminescent pigment (A) refers to the average thickness as mentioned above, and is 1 to 65 nm, or preferably 5 to 60 nm, or more preferably 10 to 50 nm.

As mentioned above, the average thickness is defined as the average value of at least 100 measured values that have been measured by observing a coating film cross-section, which includes the scaly photoluminescent pigment (A), using a transmission electron microscope (TEM).

When all photoluminescent pigment present in the multilayer coating film is projected onto a surface of the multilayer coating film, an area occupancy ratio R indicating how much of the surface of the multilayer coated film is occupied by the parts in which the photoluminescent pigment is projected, represents, when all photoluminescent pigment present in the multilayer coating film is projected onto the surface of the multilayer coating film, an area occupancy ratio indicating how much of the surface is occupied by the parts in which the photoluminescent content is projected. The area occupancy ratio R can be calculated from an image obtained by capturing the multilayer coating film from its surface side.

Under the present invention, the aforementioned area occupancy ratio (R) is 0.1 to 50 percent, or preferably 1 to 40 percent, or more preferably 5 to 30 percent.

The obtained multilayer coating film has a Y5 value, in the XYZ colorimetric system, of 20 to 1500, or preferably 50 to 1500, or more preferably 65 to 1500.

The Y5 value in the XYZ colorimetric system represents the luminance, in the XYZ colorimetric system, of the coating film when a light irradiated thereon from a 45-degree angle is received at a 5-degree angle to the specular reflection light.

It should be noted that, under the present invention, the Y5 value is measured using a multi-angle spectrophotometer (“GCMS-4,” product name, manufactured by Murakami Color Research Laboratory Co., Ltd.).

Suitably the obtained multilayer coating film has an HG value, which indicates the grainy feel, of 5 to 66, or preferably 5 to 50, or more preferably 5 to 40.

The HG value indicating grainy feel is an abbreviation of Hi-Light Graininess value. The HG value is a measure of micro-photoluminescent feel, or microscopically-observed texture, and provides a parameter indicating the grainy feel on the highlight side (of the coating film observed from near specular reflection angles to the incident light). It is obtained by capturing the coating film with a CCD camera at incident/receiving angles of 15/0 degrees, processing the obtained digital image data, or specifically two-dimensional luminance distribution data, by two-dimensional Fourier transformation, extracting from the obtained power spectral image only those spatial frequency domains responsible for grainy feel, and further converting the calculated measurement parameters to a value between 0 and 100 that maintains a linear relationship with grainy feel.

Under the present invention, the inventors of the present invention found that, when the product of the thickness T of the aforementioned scaly photoluminescent pigment (A) and the aforementioned area occupancy ratio R is within the range of Requirement (1) below and further associated with the aforementioned L*25 value, a multilayer coating film having a less grainy feel and excellent metallic gloss can be formed with ease:

T (nm)×R (%)≤2000 (1)

Regarding the obtained multilayer coating film, the L*25 value represents the brightness value L*, in the L*a*b* colorimetric system, of the multilayer coating film when a light irradiated thereon at a 45-degree angle is received at a 25-degree angle in the direction of the incident light relative to the specular reflection light.

Here, the L*a*b* colorimetric system refers to the colorimetric system specified by the International Commission on Illumination in 1976 and also adopted by JIS Z8781-4 and JIS Z8781-5, while L* is a value indicating brightness.

The L*25 value indicates highlight brightness and represents the L* value, measured with a multi-angle spectrophotometer (“CM-512m3,” product name, manufactured by Konica Minolta, Inc.), with respect to a light received at a 25-degree angle in the direction of the measurement light relative to the specular reflection angle when the measurement light is irradiated from a 45-degree angle to the axis perpendicular to the target measurement face. A higher L*25 value means a brighter highlight.

Under the present invention, a multilayer coating film having a less grainy feel and excellent metallic gloss can be formed when the aforementioned T×R range is adjusted to 2000 or smaller, or preferably 1 to 1000, or more preferably 5 to 500, in the brightness region for super-dark colors (black color region) representing a L*25 value range of 19 or smaller (L*25≤19).

Under the present invention, a multilayer coating film having a less grainy feel and excellent metallic gloss can be formed when the aforementioned T×R range is adjusted to 2000 or smaller, or preferably 100 to 2000, or more preferably 200 to 1800, in the brightness regions for dark colors representing a L*25 value range of greater than 19 but no greater than 50 (19<L*25≤50).

Under the present invention, a multilayer coating film having a less grainy feel and excellent metallic gloss can be formed when the aforementioned T×R range is adjusted to 2000 or smaller, or preferably 100 to 2000, or more preferably 250 to 2000, in the brightness regions for intermediate colors representing a L*25 value range of greater than 50 but no greater than 75 (50<L*25≤75).

Under the present invention, a multilayer coating film having a less grainy feel and excellent metallic gloss can be formed when the aforementioned T×R range is adjusted to 2000 or smaller, or preferably 10 to 1000, or more preferably 50 to 600, in the brightness regions for light colors representing a L*25 value range of greater than 75 but no greater than 90 (75<L*25≤90).

Under the present invention, a multilayer coating film having a less grainy feel and excellent metallic gloss can be formed when the aforementioned T×R range is adjusted to 2000 or smaller, or preferably 10 to 1000, or more preferably 50 to 1000, in the brightness region for super-light colors (white color region) representing a L*25 value range of greater than 90 (90<L*25).

Under the present invention, the T×R range is not much affected by hue or chroma.

Under the present invention, a multilayer coating film having a less grainy feel and excellent metallic gloss is such that, in general, its Y5 value indicating highlight luminance as mentioned above is high and its HG value indicating grainy feel as mentioned above is low, although the specifics vary depending on color tone, etc.

Under the present invention, by adjusting the aforementioned T×R range, or preferably by adjusting the aforementioned T×R range as well as Y5 value and/or HG value, or preferably by adjusting the aforementioned T×R range and L*25 value, or more preferably by adjusting the aforementioned T×R range as well as two or more types of values selected from L*25 value, Y5 value, and HG value, it can be ensured that the obtained multilayer coating film will represent a multilayer coating film having a less grainy feel and excellent metallic gloss.

### Second Embodiment

Next, the second embodiment of the present invention is explained.

The second embodiment of the present invention is a coated product having, on its surface, a multilayer coating film obtained by the method for forming multilayer coating film in the aforementioned first embodiment.

The coated product obtained by the method for forming multilayer coating film proposed by the present invention comprises the coating target described in the aforementioned first embodiment, on which a multilayer coating film obtained by the method for forming multilayer coating film in the aforementioned first embodiment has been provided.

Applications of the coated product obtained by the method for forming multilayer coating film proposed by the present invention include, for example, automotive bodies and automotive parts for passenger cars, trucks, motorcycles, etc., and preferably the coated product is shaped (into a sheet, molding, etc.) so that it can be used in the aforementioned applications.

The method for forming each coating film, thickness of each coating film, relationship of the thicknesses of respective coating films, L*25 value, Y5 value, and HG value of the multilayer coating film, and relationships thereof, etc., are the same as those described in the aforementioned first embodiment.

The coated product obtained by the method for forming multilayer coating film proposed by the present invention has a multilayer coating film having a less grainy feel and excellent metallic gloss and thus can be made into industrial products having an excellent aesthetic feel.

### Third Embodiment

Next, the third embodiment of the present invention is explained.

The third embodiment of the present invention is a multilayer coating film comprising a base coating film that has been formed on the surface of a coating target, a photoluminescent coating film containing a scaly photoluminescent pigment (A), and a clear coating film, in this order, wherein the multilayer coating film is such that:

the thickness T of the scaly photoluminescent pigment (A) is 1 to 65 nm;

when all photoluminescent pigment present in the multilayer coating film is projected onto the surface of the multilayer coating film, the area occupancy ratio R indicating how much of the surface of the multilayer coating film is occupied by the parts in which the photoluminescent pigment is projected, is 0.1 to 50 percent; and

the T and R satisfy Requirement (1) below:

T (nm)×R (%)≤2000 (1)

Under the present invention, the thickness T of the aforementioned scaly photoluminescent pigment (A) is defined in the same manner as described in the aforementioned first embodiment.

Under the present invention, the area occupancy ratio R indicating how much of the surface of the multilayer coating film is occupied by the parts in which the photoluminescent pigment is projected, is defined in the same manner as described in the aforementioned first embodiment.

The multilayer coating film will represent a metallic coating film having a less grainy feel and excellent metallic gloss when the product of the aforementioned T and R with respect to the scaly photoluminescent pigment (A) contained in the photoluminescent pigment dispersion (Y) is 2000 or smaller (T×R≤2000).

The multilayer coating film proposed by the present invention may be provided on a coating target. Here, the coating target may be the same as the coating target described in the aforementioned first embodiment.

The base coating film that constitutes the multilayer coating film proposed by the present invention may be the same as the base coating film described in the aforementioned first embodiment.

The photoluminescent coating film that constitutes the multilayer coating film proposed by the present invention may be the same as the photoluminescent coating film described in the aforementioned first embodiment, and the scaly photoluminescent pigment (A) contained in the photoluminescent coating film may be the same as the scaly photoluminescent pigment (A) described in the aforementioned first embodiment.

The clear coating film may be the same as the clear coating film described in the aforementioned first embodiment.

The method for forming multilayer coating film may be the same as described in the aforementioned first embodiment.

The film thickness of the base coating film, film thickness of the photoluminescent coating film, film thickness of the clear coating film, film thickness of the multilayer coating film, and optical characteristics (color tone, etc.) may also be the same as described in the aforementioned first embodiment.

Arbitrary layers/coating films may be provided, as necessary, between the coating target and the base coating film, between the base coating film and the photoluminescent coating film, between the photoluminescent coating film and the clear coating film, and on the clear coating film.

The multilayer coating film proposed by the present invention has a Y5 value, in the XYZ colorimetric system, of 20 to 1500, or preferably 50 to 1500, or more preferably 65 to 1500.

The Y5 value in the XYZ colorimetric system is defined in the same manner as described in the aforementioned first embodiment.

It should be noted that, in this Specification, the Y5 value is measured using a multi-angle spectrophotometer (“GCMS-4,” product name, manufactured by Murakami Color Research Laboratory Co., Ltd.) in the same manner as in the aforementioned first embodiment.

The multilayer coating film proposed by the present invention has a brightness value L* (L*25 value), in the L*a*b* colorimetric system when a light irradiated on the multilayer coating film at a 45-degree angle is received at a 25-degree angle in the direction of the incident light relative to the specular reflection light, in a range of 1 to 95.

Here, the L*a*b* colorimetric system refers to the colorimetric system specified by the International Commission on Illumination in 1976 and also adopted by JIS Z8729, while L* is a value indicating brightness.

The L*25 value indicates highlight brightness and represents the L* value, measured with a multi-angle spectrophotometer (“CM-512m3,” product name, manufactured by Konica Minolta, Inc.), with respect to a light received at a 25-degree angle in the direction of the measurement light relative to the specular reflection angle when the measurement light is irradiated from a 45-degree angle to the axis perpendicular to the target measurement face. A higher L*25 value means a brighter highlight.

Suitably the multilayer coating film proposed by the present invention has an HG value, which indicates grainy feel, of 5 to 66, or preferably 5 to 50, or more preferably 5 to 40.

The HG value indicating grainy feel is an abbreviation of Hi-Light Graininess value. The HG value is defined in the same manner as described in the aforementioned first embodiment.

Under the present invention, the inventors of the present invention found that, when the product of the thickness T of the aforementioned scaly photoluminescent pigment (A) and the aforementioned area occupancy ratio R is within the range of Requirement (1) below and further associated with the aforementioned L*25 value, a multilayer coating film having a less grainy feel and excellent metallic gloss can be formed with ease:

T (nm)×R (%)≤2000 (1)

Under the present invention, a multilayer coating film having a less grainy feel and excellent metallic gloss can be formed when the aforementioned T×R range is adjusted to 2000 or smaller, or preferably 1 to 1000, or more preferably 5 to 500, in the brightness region for super-dark colors (black color region) representing a L*25 value range of 19 or smaller (L*25≤19).

Under the present invention, a multilayer coating film having a less grainy feel and excellent metallic gloss can be formed when the aforementioned T×R range is adjusted to 2000 or smaller, or preferably 100 to 2000, or more preferably 200 to 1800, in the brightness regions for dark colors representing a L*25 value range of greater than 19 but no greater than 50 (19<L*25≤50).

Under the present invention, a multilayer coating film having a less grainy feel and excellent metallic gloss can be formed when the aforementioned T×R range is adjusted to 2000 or smaller, or preferably 100 to 2000, or more preferably 250 to 2000, in the brightness regions for intermediate colors representing a L*25 value range of greater than 50 but no greater than 75 (50<L*25≤75).

Under the present invention, a multilayer coating film having a less grainy feel and excellent metallic gloss can be formed when the aforementioned T×R range is adjusted to 2000 or smaller, or preferably 10 to 1000, or more preferably 50 to 600, in the brightness regions for light colors representing a L*25 value range of greater than 75 but no greater than 90 (75<L*25≤90).

Under the present invention, a multilayer coating film having a less grainy feel and excellent metallic gloss can be formed when the aforementioned T×R range is adjusted to 2000 or smaller, or preferably 10 to 1000, or more preferably 50 to 1000, in the brightness region for super-light colors (white color region) representing a L*25 value range of greater than 90 (90<L*25).

Under the present invention, the T×R range is not much affected by hue or chroma.

Under the present invention, a multilayer coating film having a less grainy feel and excellent metallic gloss is such that, in general, its Y5 value indicating highlight luminance as mentioned above is high and its HG value indicating grainy feel as mentioned above is low, although the specifics vary depending on color tone, etc.

Under the present invention, by adjusting the aforementioned T×R range, or preferably by adjusting the aforementioned T×R range and L*25 value, or more preferably by adjusting the foregoing as well as Y5 value and HG value, it can be ensured that the obtained multilayer coating film will represent a multilayer coating film having a less grainy feel and excellent metallic gloss.

### EXAMPLES

The present invention is explained more specifically below by citing examples and comparative examples. However, the present invention is not limited to these examples. It should be noted that “part(s)” and “percent” are all based on mass.

### Manufacturing of Acrylic Resin Water Dispersion

### Manufacturing Example 1

In a reaction container equipped with a thermometer, a thermostat, an agitation device, a reflux condenser, a nitrogen introduction tube, and a drip device, 128 parts of deionized water and 2 parts of “ADEKA REASOAP SR-1025” (product name, manufactured by ADEKA Corporation, emulsifier, active ingredient 25 percent) were placed and mixed under agitation in nitrogen streams, and then heated to 80° C.

Next, a quantity equivalent to 1 percent of the total quantity, of the monomer emulsion for core part below, and 5.3 parts of a 6% ammonium persulfate aqueous solution were introduced into the reaction container and held for 15 minutes at 80° C. Thereafter, the remaining parts of the monomer emulsion for core part were dripped over 3 hours into the reaction container being held at the same temperature, and the mixture was matured for 1 hour after the dripping had completed. Next, the monomer emulsion for shell part below was dripped over 1 hour, and the mixture was matured for 1 hour and then cooled to 30° C. while gradually adding 40 parts of a 5% 2-(dimethyl amino) ethanol aqueous solution to the reaction container, and thereafter discharged, under filtration through a 100-mesh nylon cloth, to obtain an acrylic resin water dispersion of 100 nm in average grain size and 28 percent in solids content. The obtained acrylic resin water dispersion had an acid value of 33 mgKOH/g and a hydroxyl group value of 25 mgKOH/g.

Monomer emulsion for core part: A monomer emulsion for core part was obtained by mixing 40 parts of deionized water, 2.8 parts of “ADEKA REASOAP SR-1025,” 2.1 parts of methylene bisacrylamide, 2.8 parts of styrene, 16.1 parts of methyl methacrylate, 28 parts of ethyl acrylate, and 21 parts of n-butyl acrylate, under agitation.

Monomer emulsion for shell part: A monomer emulsion for shell part was obtained by mixing 17 parts of deionized water, 1.2 parts of “ADEKA REASOAP SR-1025,” 0.03 parts of ammonium persulfate, 3 parts of styrene, 5.1 parts of 2-hydroxyethyl acrylate, 5.1 parts of methacrylic acid, 6 parts of methyl methacrylate, 1.8 parts of ethyl acrylate, and 9 parts of n-butyl acrylate, under agitation.

### Manufacturing of Photoluminescent Pigment Dispersion (Y)

### Manufacturing Example 2

The respective components were compounded at these ratios (by quantities that represent 100 parts by mass in total) and then mixed under agitation to prepare a photoluminescent pigment dispersion (Y-1): 0.13 parts by mass of “Hydroshine WS-6001” (product name, aqueous vapor-deposited aluminum flake pigment, manufactured by Eckart GmbH, solids content: 10 percent by mass, internal solvent: isopropanol 70.0 percent by mass/butyl glycol 20.0 percent by mass, average grain size D50: 10 μm, thickness: 13.5 nm, silica-treated surface), 74.06 parts by mass of “Rheocrysta” (cellulose nanofiber-based viscosity-adjusting agent, manufactured by Dai-ichi Kogyo Seiyaku Co., Ltd., solids content: 0.5 percent), 0.31 parts by mass of the surface conditioner “Dynol 604” (product name, manufactured by Nissin Chemical Co., Ltd., acetylenediol-based surface conditioner, HLB: 8, nonvolatile content: 100 percent by mass), 2.2 parts by mass of the acrylic resin water dispersion obtained in Manufacturing Example 1 above, 0.01 parts by mass of dimethyl ethanolamine, 0.49 parts by mass of an aqueous solvent, and 22.8 parts by mass of distilled water.

### Manufacturing Examples 3 to 25

Photoluminescent pigment dispersions (Y-2) to (Y-24) were obtained in the exact same manner as in Manufacturing Example 2, except that the compositions described in Table 1 were used.

The details of the raw materials in the table are shown below.

WS-6001:

Product name “Hydroshine WS-6001,” manufactured by Eckart GmbH, aqueous vapor-deposited aluminum flake pigment, solids content: 10.0 percent, internal solvent: isopropanol 70.0 percent/butyl glycol 20.0 percent, average grain size (D50): 10.0 μm, thickness: 13.5 nm, silica-treated surface

Liquid Black:

Product name “Metalure Liquid Black,” manufactured by Eckart GmbH, aqueous vapor-deposited chrome oxide flake pigment, solids content: 10.0 percent, internal solvent: 1-methoxy-2-propanol 90.0 percent, average grain size (D50): 14.0 μm, thickness: 20.0 nm

WS-4140:

Product name “Hydroshine WS-4140,” manufactured by Eckart GmbH, aqueous vapor-deposited aluminum flake pigment, solids content: 10.0 percent, internal solvent: isopropanol 70.0 percent/butyl glycol 20.0 percent, average grain size (D50): 14.0 μm, thickness: 22.5 nm, silica-treated surface

WS-4001

Product name “Hydroshine WS-4001,” manufactured by Eckart GmbH, aqueous vapor-deposited aluminum flake pigment, solids content: 10.0 percent, internal solvent: isopropanol 70.0 percent/butyl glycol 20.0 percent, average grain size (D50): 10.5 μm, thickness: 22.5 nm, silica-treated surface

WS-3004:

Product name “Hydroshine WS-3004,” manufactured by Eckart GmbH, aqueous vapor-deposited aluminum flake pigment, solids content: 10.0 percent, internal solvent: isopropanol 90.0 percent, average grain size (D50): 11.0 μm, thickness: 50.0 nm, silica-treated surface

WS-3001:

Product name “Hydroshine WS-3001,” manufactured by Eckart GmbH, aqueous vapor-deposited aluminum flake pigment, solids content: 10.0 percent, internal solvent: isopropanol 90.0 percent, average grain size (D50): 11.1 μm, thickness: 50.0 nm, silica-treated surface

S 1500:

Product name “STAPA IL Hydrolan S 1500,” manufactured by Eckart GmbH, milling aluminum flake pigment, solids content: 20.0 percent, internal solvent: isopropanol 80.0 percent, average grain size (D50): 15.0 μm, thickness: 50.0 nm, silica-treated surface

S 1100:

Product name “STAPA IL Hydrolan S 1100,” manufactured by Eckart GmbH, milling aluminum flake pigment, solids content: 50.0 percent, internal solvent: isopropanol 50.0 percent, average grain size (D50): 11.0 μm, thickness: 80.0 nm, silica-treated surface

S 2100:

Product name “STAPA IL Hydrolan S 2100,” manufactured by Eckart GmbH, milling aluminum flake pigment, solids content: 60.0 percent, internal solvent: isopropanol 40.0 percent, average grain size (D50): 22.0 μm, thickness: 130.0 nm, silica-treated surface

Rheocrysta:

Product name “Rheocrysta,” manufactured by Dai-ichi Kogyo Seiyaku Co., Ltd., cellulose-based viscosity-adjusting agent=cellulose nanofiber gel, solids content: 0.5 percent

ASE-60:

Product name “Acrysol ASE-60,” manufactured by Dow Chemical Company, polyacrylic acid-based viscosity-adjusting agent, solids content: 28 percent

Dynol 604:

Product name “Dynol 604,” manufactured by Evonik Industries AG, acetylenediol-based surface conditioner, HLB value: 8, nonvolatile content: 100 percent by mass

Colored Pigment Dispersion Liquid

Manufactured according to the method described below, using the hydroxyl group-containing acrylic resin described below.

(Manufacturing of Hydroxyl Group-Containing Acrylic Resin)

In a reaction container equipped with a thermometer, a thermostat, an agitation device, a reflux condenser, a nitrogen introduction tube, and a drip device, 35 parts by mass of propylene glycol monopropyl ether were placed and heated to 85° C., after which a mixture containing methyl methacrylate by 32 parts by mass, n-butyl acrylate by 27.7 parts by mass, 2-ethylhexyl acrylate by 20 parts by mass, 4-hydroxybutyl acrylate by 10 parts by mass, hydroxypropyl acrylate by 3 parts by mass, acrylic acid by 6.3 parts by mass, 2-acryloyloxyethyl acid phosphate by 1 part by mass, propylene glycol monopropyl ether by 15 parts by mass, and 2,2′-azobis(2,4-dimethyl valeronitrile) by 2.3 parts by mass, was dripped over 4 hours and the resulting mixture was matured for 1 hour after the dripping had completed. Thereafter, a mixture of 10 parts by mass of propylene glycol monopropyl ether and 1 part by mass of 2,2′-azobis(2,4-dimethyl valeronitrile) was further dripped over 1 hour and the resulting mixture was matured for 1 hour after the dripping had completed. Furthermore, 7.4 parts by mass of diethanolamine were added, to obtain a hydroxyl group-containing acrylic resin solution of 55 percent in solids content. The obtained hydroxyl group-containing acrylic resin had an acid value of 51 mgKOH/g and a hydroxyl group value of 52 mgKOH/g.

(Manufacturing of Colored Pigment Dispersion Liquid)

Into an agitation-mixing container, 25.4 parts by mass of the aforementioned hydroxyl group-containing acrylic resin (solids content 14.0 parts by mass), 7 parts by mass of “Raven 5000 Ultra III” (product name, carbon black pigment, manufactured by Birla Carbon), and 66.6 parts by mass of deionized water, were put and uniformly mixed, after which 2-(dimethyl amino) ethanol was added to adjust the pH to 7.5. The obtained mixture was put in a resinous bottle of 225 ml in capacity, 130 parts by mass of zirconia beads of 1.5 mm in diameter were introduced therein and the bottle was sealed, and the content was dispersed for 120 minutes using a shaker-type paint conditioner. After the dispersion, the zirconia beads were removed by filtration trough a 100-mesh woven metal wire to obtain a black pigment dispersion of 20.9 percent by mass in solids content.

TABLE 1

| | Manufacturing Example No. | | | | | | | | | | |
|---|---|---|---|---|---|---|---|---|---|---|---|
| | 2 | 3 | 4 | 5 | 6 | 7 | 8 | 9 | 10 | 11 | 12 |
| Photoluminescent | Y-1 | Y-2 | Y-3 | Y-4 | Y-5 | Y-6 | Y-7 | Y-8 | Y-9 | Y-10 | Y-11 |
| pigment | | | | | | | | | | | |
| dispersion (Y) | | | | | | | | | | | |
| Distilled water | 22.80 | 22.68 | 22.45 | 22.23 | 22.09 | 1.49 | 22.74 | 22.74 | 22.39 | 21.32 | 21.05 |
| WS-6001 | 0.13 | 0.26 | 0.51 | 0.76 | 0.89 | | | | | | |
| Liquid Black | | | | | | 23.19 | | | | | |
| WS-4140 | | | | | | | 0.19 | | | | |
| WS-4001 | | | | | | | | 0.19 | 0.57 | 1.72 | 2.02 |
| WS-3004 | | | | | | | | | | | |
| WS-3001 | | | | | | | | | | | |
| S1500 | | | | | | | | | | | |
| S1100 | | | | | | | | | | | |
| S2100 | | | | | | | | | | | |
| Rheocrysta | 74.06 | 74.05 | 74.03 | 74.00 | 74.01 | 72.36 | 74.06 | 74.06 | 74.03 | 73.95 | 73.92 |
| ASE-60 | | | | | | | | | | | |
| Dynol 604 | 0.31 | 0.31 | 0.31 | 0.31 | 0.31 | 0.31 | 0.31 | 0.31 | 0.31 | 0.31 | 0.31 |
| Acrylic resin | 2.20 | 2.20 | 2.20 | 2.20 | 2.20 | 2.15 | 2.20 | 2.20 | 2.20 | 2.20 | 2.20 |
| water dispersion | | | | | | | | | | | |
| Dimethyl | 0.01 | 0.01 | 0.01 | 0.01 | 0.01 | 0.01 | 0.01 | 0.01 | 0.01 | 0.01 | 0.01 |
| ethanolamine | | | | | | | | | | | |
| Aqueous solvent | 0.49 | 0.49 | 0.49 | 0.49 | 0.49 | 0.49 | 0.49 | 0.49 | 0.49 | 0.49 | 0.49 |
| Colored pigment | | | | | | | | | | | |
| dispersion liquid | | | | | | | | | | | |
| Total | 100.00 | 100.00 | 100.00 | 100.00 | 100.00 | 100.00 | 100.00 | 100.00 | 100.00 | 100.00 | 100.00 |

| | Manufacturing Example No. | | | | | | | | | | | | |
|---|---|---|---|---|---|---|---|---|---|---|---|---|---|
| | 13 | 14 | 15 | 16 | 17 | 18 | 19 | 20 | 21 | 22 | 23 | 24 | 25 |
| Photoluminescent | Y-12 | Y-13 | Y-14 | Y-15 | Y-16 | Y-17 | Y-18 | Y-19 | Y-20 | Y-21 | Y-22 | Y-23 | Y-24 |
| pigment | | | | | | | | | | | | | |
| dispersion (Y) | | | | | | | | | | | | | |
| Distilled water | 22.84 | 22.76 | 21.54 | 22.78 | 59.15 | 95.52 | 22.69 | 22.49 | 21.65 | 22.53 | 22.90 | 22.85 | 22.90 |
| WS-6001 | | | | | | | | | | | | | |
| Liquid Black | | | | | | | | | | | | | |
| WS-4140 | | | | | | | | | | | | | |
| WS-4001 | | | | | | | | | | | | | |
| WS-3004 | 0.08 | 0.17 | 1.49 | | | | | | | | | | |
| WS-3001 | | | | 0.15 | 0.15 | 0.15 | 0.15 | 0.46 | 1.37 | | | | |
| S1500 | | | | | | | | | | 0.45 | | | |
| S1100 | | | | | | | | | | | 0.03 | 0.11 | |
| S2100 | | | | | | | | | | | | | 0.03 |
| Rheoctysta | 74.07 | 74.06 | 73.96 | 74.06 | 37.03 | | 74.05 | 74.04 | 73.97 | 74.01 | 74.06 | 74.03 | 74.06 |
| ASE-60 | | | | | 0.66 | 1.32 | | | | | | | |
| Dynol 604 | 0.31 | 0.31 | 0.31 | 0.31 | 0.31 | 0.31 | 0.31 | 0.31 | 0.31 | 0.31 | 0.31 | 0.31 | 0.31 |
| Acrylic resin | 2.20 | 2.20 | 2.20 | 2.20 | 2.20 | 2.20 | 2.20 | 2.20 | 2.20 | 2.20 | 2.20 | 2.20 | 2.20 |
| water dispersion | | | | | | | | | | | | | |
| Dimethyl | 0.01 | 0.01 | 0.01 | 0.01 | 0.01 | 0.01 | 0.01 | 0.01 | 0.01 | 0.01 | 0.01 | 0.01 | 0.01 |
| ethanolamine | | | | | | | | | | | | | |
| Aqueous solvent | 0.49 | 0.49 | 0.49 | 0.49 | 0.49 | 0.49 | 0.49 | 0.49 | 0.49 | 0.49 | 0.49 | 0.49 | 0.49 |
| Colored pigment | | | | | | | 0.10 | | | | | | |
| dispersion liquid | | | | | | | | | | | | | |
| Total | 100.00 | 100.00 | 100.00 | 100.00 | 100.00 | 100.00 | 100.00 | 100.00 | 100.00 | 100.00 | 100.00 | 100.00 | 100.00 |

### (Production of Coating Target)

Coating Target 1

A degreased and zinc phosphate-treated steel sheet (JIS G3141, size 400 mm×300 mm×0.8 mm) was electrodeposition-coated with the cationic electrodeposition coating material “Eleclon GT-10” (product name, manufactured by Kansai Paint Co., Ltd., epoxy resin polyamine-based cationic resin using a blocked polyisocyanate compound as a crosslinking agent) to a film thickness of 20 μm based on cured coating film, and then heated for 20 minutes at 170° C. to cause the coating material to crosslink and cure and thus form an electrodeposition coating film, for use as a coating target 1.

### Preparation of Test Sheets

### Example 1

A base coating material (X-1) based on Kansai Paint's polyester resin-based aqueous middle-coat coating material (WP-522H), which had been color-adjusted so that the L*45, a*45, and b*45 of the base coating film would match the values in Table 2, was electrostatically coated on the coating target 1 above using a rotary-atomization type bell-shaped coating machine, to a cured film thickness of 20 μm, and the film was let stand for 3 minutes, to form a base coating film.

Furthermore, on the base coating film, the photoluminescent pigment dispersion (Y-1) prepared as described above, which had been adjusted to the coating material viscosity shown in Table 1, was applied using ABB's Robot Bell applicator under the conditions of 23° C. in booth temperature and 68 percent in humidity, to achieve a cured coating film of 1.5 μm. The film was let stand for 3 minutes, and then preheated for 3 minutes at 80° C., to form a photoluminescent coating film.

Next, on this photoluminescent coating film, the clear coating material (Z-1) “KINO 6510” (product name, manufactured by Kansai Paint Co., Ltd., acrylic resin/urethane resin-based two-component, organic-solvent type coating material of hydroxyl group/isocyanate group curable type) was applied using ABB's Robot Bell applicator under the conditions of 23° C. in booth temperature and 68 percent in humidity, to achieve a cured coating film of 35 μm, to form a clear coating film. After it had been coated, the film was let stand for 7 minutes at room temperature and then heated using the interior of a hot air circulation type drying furnace for 30 minutes at 140° C. to simultaneously cure the multilayer coating film, for use as a test sheet.

Here, the film thickness of cured coating film was calculated using the formula below. The same applies to the following Examples:

x=sc/sg/S*10000

x: Film thickness [μm]

sc: Coated solids content [g]

sg: Specific gravity of coating film [g/cm³]

S: Evaluation area of coated solids content [cm²]

### Examples 2 to 28, Comparative Examples 1 to 6

Test sheets were obtained in the exact same manner as in Example 1, except that the L*45 values, a*45 values, and b*45 values of the base coating films were adjusted to those shown in Table 2, the photoluminescent pigment dispersions (Y) shown in Table 2 or Table 3 were used, and multilayer coating films were formed as photoluminescent coating films having the cured film thicknesses shown in Table 2 or Table 3.

### Coating Film Evaluation

The test sheets obtained as above were each evaluated for their multilayer coating film, the results of which are also shown in Table 2 and Table 3.

TABLE 2

| | Examples | | | | | | | | | |
|---|---|---|---|---|---|---|---|---|---|---|
| | 1 | 2 | 3 | 4 | 5 | 6 | 7 | 8 | 9 | 10 |
| Coating target | 1 | 1 | 1 | 1 | 1 | 1 | 1 | 1 | 1 | 1 |
| Base color (X) | X-1 | X-1 | X-1 | X-1 | X-1 | X-1 | X-1 | X-1 | X-1 | X-1 |
| Base color (X) L*45 | 1.5 | 1.5 | 1.5 | 1.5 | 1.5 | 1.5 | 1.5 | 1.5 | 1.5 | 1.5 |
| Base color (X) a*45 | −0.1 | −0.1 | −0.1 | −0.1 | −0.1 | −0.1 | −0.1 | −0.1 | −0.1 | −0.1 |
| Base color (X) b*45 | −0.1 | −0.1 | −0.1 | −0.1 | −0.1 | −0.1 | −0.1 | −0.1 | −0.1 | −0.1 |
| Photoluminescent pigment | Y-1 | Y-2 | Y-3 | Y-4 | Y-6 | Y-7 | Y-8 | Y-9 | Y-10 | Y-12 |
| dispersion (Y) | | | | | | | | | | |
| Clear coating material (Z) | Z-1 | Z-1 | Z-1 | Z-1 | Z-1 | Z-1 | Z-1 | Z-1 | Z-1 | Z-1 |
| Scaly photoluminescent | WS- | WS- | WS- | WS- | L- | WS- | WS- | WS- | WS- | WS- |
| pigment (A) type | 6001 | 6001 | 6001 | 6001 | Black | 4140 | 4001 | 4001 | 4001 | 3004 |
| Scaly photoluminescent pigment | 10.0 | 10.0 | 10.0 | 10.0 | 14.0 | 14.0 | 10.5 | 10.5 | 10.5 | 11.0 |
| (A) average grain size (D50) | | | | | | | | | | |
| (μm) | | | | | | | | | | |
| Scaly photoluminescent pigment | 13.5 | 13.5 | 13.5 | 13.5 | 20.0 | 22.5 | 22.5 | 22.5 | 22.5 | 50.0 |
| (A) thickness T (nm) | | | | | | | | | | |
| Area occupancy ratio R (%) | 5.30 | 14.00 | 24.30 | 48.30 | 30.10 | 10.30 | 11.90 | 21.40 | 46.80 | 4.00 |
| T (nm) × R( %) | 72 | 189 | 328 | 652 | 602 | 232 | 268 | 482 | 1053 | 200 |
| L*25 | 10.1 | 18.2 | 24.9 | 32.1 | 28.5 | 18.0 | 26.1 | 37.1 | 55.3 | 16.6 |
| Y5 value | 80 | 150 | 235 | 383 | 420 | 177 | 155 | 238 | 549 | 60 |
| HG value | 10 | 12 | 16 | 48 | 45 | 14 | 36 | 59 | 61 | 27 |
| (Y) film thickness (μm) | 0.4 | 0.4 | 0.3 | 0.4 | 0.5 | 0.4 | 0.4 | 0.4 | 0.4 | 0.5 |

| | Examples | | | | | | | | |
|---|---|---|---|---|---|---|---|---|---|
| | 11 | 12 | 13 | 14 | 15 | 16 | 17 | 18 | 19 |
| Coating target | 1 | 1 | 1 | 1 | 1 | 1 | 1 | 1 | 1 |
| Base color (X) | X-1 | X-1 | X-1 | X-2 | X-3 | X-4 | X-5 | X-6 | X-7 |
| Base color (X) L*45 | 1.5 | 1.5 | 1.5 | 21.2 | 41.5 | 61.9 | 80.8 | 90.3 | 85.6 |
| Base color (X) a*45 | −0.1 | −0.1 | −0.1 | −0.5 | −0.2 | −1.0 | −0.9 | −1.2 | −7.7 |
| Base color (X) b*45 | −0.1 | −0.1 | −0.1 | −2.2 | −1.6 | 0.8 | 3.6 | 3.6 | 62.1 |
| Photoluminescent pigment | Y-13 | Y-14 | Y-15 | Y-15 | Y-15 | Y-15 | Y-15 | Y-15 | Y-15 |
| dispersion (Y) | | | | | | | | | |
| Clear coating material (Z) | Z-1 | Z-1 | Z-1 | Z-1 | Z-1 | Z-1 | Z-1 | Z-1 | Z-1 |
| Scaly photoluminescent | WS- | WS- | WS- | WS- | WS- | WS- | WS- | WS- | WS- |
| pigment (A) type | 3004 | 3004 | 3001 | 3001 | 3001 | 3001 | 3001 | 3001 | 3001 |
| Scaly photoluminescent | 11.0 | 11.0 | 11.1 | 11.1 | 11.1 | 11.1 | 11.1 | 11.1 | 11.1 |
| pigment (A) average | | | | | | | | | |
| grain size (D50) (μm) | | | | | | | | | |
| Scaly photoluminescent | 50.0 | 50.0 | 50.0 | 50.0 | 50.0 | 50.0 | 50.0 | 50.0 | 50.0 |
| pigment (A) thickness | | | | | | | | | |
| T (nm) | | | | | | | | | |
| Area occupancy ratio R (%) | 8.00 | 39.50 | 10.80 | 10.50 | 10.00 | 8.50 | 8.50 | 8.40 | 8.50 |
| T (nm) × R (%) | 400 | 1975 | 540 | 525 | 500 | 425 | 425 | 420 | 425 |
| L*25 | 23.1 | 54.6 | 25.9 | 33.2 | 60.5 | 78.5 | 86.6 | 92.9 | 89.8 |
| Y5 value | 131 | 544 | 142 | 152 | 176 | 196 | 214 | 219 | 215 |
| HG value | 43 | 65 | 41 | 37 | 23 | 16 | 15 | 15 | 15 |
| (Y) film thickness (μm) | 0.5 | 0.5 | 0.5 | 0.5 | 0.5 | 0.5 | 0.5 | 0.5 | 0.5 |

TABLE 3

| | Examples | | | | | | | | |
|---|---|---|---|---|---|---|---|---|---|
| | 20 | 21 | 22 | 23 | 24 | 25 | 26 | 27 | 28 |
| Coating target | 1 | 1 | 1 | 1 | 1 | 1 | 1 | 1 | 1 |
| Base color (X) | X-8 | X-9 | X-10 | X-11 | X-1 | X-1 | X-1 | X-1 | X-1 |
| Base color (X) L*45 | 62.7 | 57.1 | 52.4 | 44.6 | 1.5 | 1.5 | 1.5 | 1.5 | 1.5 |
| Base color (X) a*45 | 40.9 | −57.5 | 52.5 | −17.5 | −0.1 | −0.1 | −0.1 | −0.1 | −0.1 |
| Base color (X) b*45 | −7.6 | 17.4 | 53.9 | −42.4 | −0.1 | −0.1 | −0.1 | −0.1 | −0.1 |
| Photoluminescent pigment | Y-15 | Y-15 | Y-15 | Y-15 | Y-16 | Y-17 | Y-18 | Y-19 | Y-21 |
| dispersion (Y) | | | | | | | | | |
| Clear coating material (Z) | Z-1 | Z-1 | Z-1 | Z-1 | Z-1 | Z-1 | Z-1 | Z-1 | Z-1 |
| Scaly photoluminescent | WS- | WS- | WS- | WS- | WS- | WS- | WS- | WS- | S1500 |
| pigment | 3001 | 3001 | 3001 | 3001 | 3001 | 3001 | 3001 | 3001 | |
| (A) type | | | | | | | | | |
| Scaly photoluminescent | 11.1 | 11.1 | 11.1 | 11.1 | 11.1 | 11.1 | 11.1 | 11.1 | 15.0 |
| pigment (A) average | | | | | | | | | |
| grain size (D50) | | | | | | | | | |
| (μm) | | | | | | | | | |
| Scaly photoluminescent | 50.0 | 50.0 | 50.0 | 50.0 | 50.0 | 50.0 | 50.0 | 50.0 | 50 |
| pigment (A) thickness | | | | | | | | | |
| T (nm) | | | | | | | | | |
| Area occupancy ratio R (%) | 8.50 | 8.50 | 9.20 | 10.00 | 10.50 | 10.20 | 8.20 | 26.20 | 20.10 |
| T × R | 425 | 425 | 460 | 500 | 525 | 510 | 410 | 1310 | 1005 |
| L*25 | 77.7 | 74.1 | 70.4 | 63.6 | 24.3 | 23.1 | 17.5 | 41.1 | 57.1 |
| Y5 value | 198 | 190 | 182 | 178 | 138 | 116 | 102 | 351 | 777 |
| HG value | 16 | 17 | 20 | 21 | 42 | 43 | 35 | 52 | 55 |
| (Y) fdm thickness (μm) | 0.5 | 0.5 | 0.5 | 0.5 | 0.5 | 0.5 | 0.5 | 0.7 | 0.5 |

Comparative Examples

| | 1 | 2 | 3 | 4 | 5 | 6 |
|---|---|---|---|---|---|---|
| Coating target | 1 | 1 | 1 | 1 | 1 | 1 |
| Base color (X) | X-1 | X-1 | X-1 | X-1 | X-1 | X-1 |
| Base color (X) L*45 | 1.5 | 1.5 | 1.5 | 1.5 | 1.5 | 1.5 |
| Base color (X) a*45 | −0.1 | −0.1 | −0.1 | −0.1 | −0.1 | −0.1 |
| Base color (X) b*45 | −0.1 | −0.1 | −0.1 | −0.1 | −0.1 | −0.1 |
| Photoluminescent pigment | Y-5 | Y-11 | Y-20 | Y-22 | Y-23 | Y-24 |
| dispersion (Y) | | | | | | |
| Clear coating material (Z) | Z-1 | Z-1 | Z-1 | Z-1 | Z-1 | Z-1 |
| Scaly photoluminescent | WS- | WS- | WS- | S1100 | S1100 | S2100 |
| pigment (A) type | 6001 | 4001 | 3001 | | | |
| Scaly photoluminescent | 10.0 | 10.5 | 11.1 | 11.0 | 11.0 | 22.0 |
| pigment (A) average grain | | | | | | |
| size (D50) (μm) | | | | | | |
| Scaly photoluminescent | 13.5 | 22.5 | 50.0 | 80 | 80 | 130 |
| pigment (A) thickness | | | | | | |
| T (nm) | | | | | | |
| Area occupancy | 53.20 | 56.70 | 48.70 | 6.00 | 19.00 | 4.20 |
| ratio R (%) | | | | | | |
| T × R | 718 | 1276 | 2435 | 480 | 1520 | 546 |
| L*25 | 36.2 | 58.1 | 64.5 | 13.5 | 30.9 | 13.9 |
| Y5 value | 457 | 621 | 872 | 26 | 78 | 36 |
| HG value | 70 | 72 | 66 | 18 | 69 | 22 |
| (Y) film thickness (μm) | 0.4 | 0.4 | 0.9 | 0.5 | 0.5 | 0.5 |

L*45 Value

The L*45 value indicates brightness in the L*a*b* colorimetric system and represents the L* value, measured with a multi-angle spectrophotometer (“CM-512m3,” product name, manufactured by Konica Minolta, Inc.), with respect to a light received at a 45-degree angle in the direction of the measurement light relative to the specular reflection angle when the measurement light is irradiated from a 45-degree angle to the axis perpendicular to the target measurement face on the surface of the base coating film.

a*45 Value

The a*45 value indicates brightness in the L*a*b* colorimetric system and represents the a* value, measured with a multi-angle spectrophotometer (“CM-512m3,” product name, manufactured by Konica Minolta, Inc.), with respect to a light received at a 45-degree angle in the direction of the measurement light relative to the specular reflection angle when the measurement light is irradiated from a 45-degree angle to the axis perpendicular to the target measurement face on the surface of the base coating film.

b*45 Value

The b*45 value indicates brightness in the L*a*b* colorimetric system and represents the b* value, measured with a multi-angle spectrophotometer (“CM-512m3,” product name, manufactured by Konica Minolta, Inc.), with respect to a light received at a 45-degree angle in the direction of the measurement light relative to the specular reflection angle when the measurement light is irradiated from a 45-degree angle to the axis perpendicular to the target measurement face on the surface of the base coating film.

L*25 Value

The L*25 value indicates brightness in the L*a*b* colorimetric system and represents the L* value, measured with a multi-angle spectrophotometer (“CM-512m3,” product name, manufactured by Konica Minolta, Inc.), with respect to a light received at a 25-degree angle in the direction of the measurement light relative to the specular reflection angle when the measurement light is irradiated from a 45-degree angle to the axis perpendicular to the target measurement face on the surface of the multilayer coating film. A higher L*25 value means a brighter highlight.

Y5 Value

The Y5 value indicates luminance in the XYZ colorimetric system and represents the Y value, measured with a multi-angle spectrophotometer (“GCMS-4,” product name, manufactured by Murakami Color Research Laboratory Co., Ltd.), with respect to a light received at a 5-degree angle in the direction of the measurement light relative to the specular reflection angle when the measurement light is irradiated from a 45-degree angle to the axis perpendicular to the target measurement face on the surface of the multilayer coating film. A higher Y5 value means a brighter highlight on the coating film.

HG Value

The HG value is an abbreviation of Hi-Light Graininess value. The HG value is a measure of micro-photoluminescent feel of a coating film surface when observed microscopically, and provides an index for the grainy feel on the highlight side. The HG value is calculated as follows. First, the multilayer coating film surface is captured with a CCD camera at incident/receiving angles of 15/0 degrees, and the obtained digital image data (two-dimensional luminance distribution data) is processed by two-dimensional Fourier transformation to obtain a power spectral image. Next, from this power spectral image, only those spatial frequency domains responsible for grainy feel are extracted and the obtained measurement parameters are converted to a value between 0 and 100 that maintains a linear relationship with grainy feel. The HG value is 0 when the photoluminescent pigment does not feel grainy at all, and 100 when the photoluminescent pigment feels the grainiest.

The foregoing specifically explained the embodiments and examples of the present invention; it should be noted, however, that the present invention is not limited to the aforementioned embodiments and various modifications are possible based on the technical ideas of the present invention.

For example, the constitutions, methods, steps, shapes, materials, values, etc., mentioned in the aforementioned embodiments and examples are provided solely as examples, and constitutions, methods, steps, shapes, materials, values, etc., different therefrom may be used as necessary.

Also, the constitutions, methods, steps, shapes, materials, values, etc., in the aforementioned embodiments can be combined, so long as doing so does not deviate from the main points of the present invention.

1. A method for forming a multilayer coating film that includes steps (1) to (3) below in this order:
(1) a step to form a base coating film on a coating target by applying a base coating material (X);
(2) a step to form a photoluminescent coating film by applying a photoluminescent pigment dispersion (Y); and
(3) a step to form a clear coating film by applying a clear coating material (Z);
wherein,
the photoluminescent pigment dispersion (Y) is a photoluminescent pigment dispersion containing a scaly photoluminescent pigment (A), and a thickness T of the scaly photoluminescent pigment (A) is 1 to 65 nm;
when all photoluminescent pigment present in the multilayer coating film is projected onto a surface of the multilayer coating film, an area occupancy ratio R indicating how much of the surface of the multilayer coating film is occupied by parts in which the photoluminescent pigment is projected, is 0.1 to 50 percent; and
the T and R satisfy requirement (1) below:
T (nm)×R (%)≤2000 (1).

2. The method for forming a multilayer coating film according to claim 1, wherein a Y value (Y5) indicating luminance, in the XYZ colorimetric system based on spectral reflectivity, of the multilayer coating film when a light irradiated thereon at a 45-degree angle is received at a 5-degree angle in a direction of an incident light relative to a specular reflection light, is 20 to 1500.

3. The method for forming a multilayer coating film according to claim 1, wherein an HG value of the multilayer coating film is in a range of 5 to 66.

4. The method for forming a multilayer coating film according to claim 1, wherein a content of the scaly photoluminescent pigment (A) is 0.2 to 80 parts by mass relative to 100 parts by mass of a total solids content in the photoluminescent pigment dispersion (Y).

5. The method for forming a multilayer coating film according to claim 1, wherein the photoluminescent pigment dispersion (Y) contains a viscosity-adjusting agent.

6. The method for forming a multilayer coating film according to claim 1, wherein the clear coating material (Z) is a two-component type clear coating material containing a hydroxyl group-containing resin and a polyisocyanate compound.

7. A coated product having, on its surface, a multilayer coating film obtained by the method for forming a multilayer coating film according to claim 1.

8. A multilayer coating film comprising a base coating film that has been formed on a surface of a coating target, a photoluminescent coating film containing a scaly photoluminescent pigment (A), and a clear coating film, in this order:
wherein,
a thickness T of the scaly photoluminescent pigment (A) is 1 to 65 nm;
when all photoluminescent pigment present in the multilayer coating film is projected onto a surface of the multilayer coating film, an area occupancy ratio R indicating how much of the surface of the multilayer coating film is occupied by parts in which the photoluminescent pigment is projected, is 0.1 to 50 percent; and
the T and R satisfy requirement (1) below:
T (nm)×R (%)≤2000 (1).

9. The method for forming a multilayer coating film according to claim 2, wherein an HG value of the multilayer coating film is in a range of 5 to 66.

10. The method for forming a multilayer coating film according to claim 2, wherein a content of the scaly photoluminescent pigment (A) is 0.2 to 80 parts by mass relative to 100 parts by mass of a total solids content in the photoluminescent pigment dispersion (Y).

11. The method for forming a multilayer coating film according claim 2, wherein the photoluminescent pigment dispersion (Y) contains a viscosity-adjusting agent.

12. The method for forming a multilayer coating film according to claim 2, wherein the clear coating material (Z) is a two-component type clear coating material containing a hydroxyl group-containing resin and a polyisocyanate compound.

13. A coated product having, on its surface, a multilayer coating film obtained by the method for forming a multilayer coating film according to claim 2.

14. The method for forming a multilayer coating film according to claim 3, wherein a content of the scaly photoluminescent pigment (A) is 0.2 to 80 parts by mass relative to 100 parts by mass of a total solids content in the photoluminescent pigment dispersion (Y).

15. The method for forming a multilayer coating film according claim 3, wherein the photoluminescent pigment dispersion (Y) contains a viscosity-adjusting agent.

16. The method for forming a multilayer coating film according to claim 3, wherein the clear coating material (Z) is a two-component type clear coating material containing a hydroxyl group-containing resin and a polyisocyanate compound.

17. A coated product having, on its surface, a multilayer coating film obtained by the method for forming a multilayer coating film according to claim 3.

18. The method for forming a multilayer coating film according claim 4, wherein the photoluminescent pigment dispersion (Y) contains a viscosity-adjusting agent.

19. The method for forming a multilayer coating film according to claim 4, wherein the clear coating material (Z) is a two-component type clear coating material containing a hydroxyl group-containing resin and a polyisocyanate compound.

20. A coated product having, on its surface, a multilayer coating film obtained by the method for forming a multilayer coating film according to claim 4.
